(19) United States
(12) Patent Application Publication
(10) Pub. No.: US 2026/0351582 A1
(43) Pub. Date: Nov. 5, 2026

(54) SYSTEMS AND METHODS FOR FAST CHARGE LITHIUM-ION BATTERIES

(71) Applicant: University of Virginia Patent Foundation, Charlottesville, VA (US)

(72) Inventors: Gary M. Koenig, Fishersville, VA (US); Chen Cai, Charlottesville, VA (US)

(21) Appl. No.: 19/529,397

(22) Filed: Feb. 4, 2026

Related U.S. Application Data
(60) Provisional application No. 63/755,022, filed on Feb. 6, 2025.

(51) Int. Cl. H01M 4/38; H01M 4/02; H01M 4/131; H01M 4/134; H01M 4/136; H01M 4/505; H01M 4/525; H01M 4/58; H01M 4/62; H01M 10/0525; H01M 10/0569; H01M 10/44

(52) U.S. Cl. CPC H01M 4/386; H01M 4/131; H01M 4/134; H01M 4/136; H01M 4/387; H01M 4/505; H01M 4/525; H01M 4/5825; H01M 4/625; H01M 10/0525; H01M 10/0569; H01M 10/44; H01M 2004/021; H01M 2004/027; H01M 2004/028

(57) ABSTRACT

In one aspect, the disclosure relates to batteries comprising an anode, a cathode, and an electrolyte. An anode can comprise a lithium-silicon compound, lithium-tin alloys, or lithium titanate. A cathode can comprise a lithium transition metal oxide or lithium transition metal phosphate. The battery can have the characteristic to be charged via a constant voltage only charging protocol.

### CROSS-REFERENCE TO RELATED APPLICATIONS

This application claims the benefit of and priority to U.S. Provisional Application No. 63/755,022, filed on Feb. 6, 2025, which is incorporated herein by reference in its entirety.

### BACKGROUND

Lithium (Li)-ion batteries provide rechargeable power options for broad applications that require high energy density. Conventional graphite anodes achieve high energy density, but operate at voltages where under fast charging conditions Li plating can initiate. Carbonate solvents generally coupled with graphite anodes also have relatively high viscosity which limit transport capabilities and charging rates for Li-ion cells. Therefore, there are still limitations to the current technologies.

### SUMMARY

The present disclosure provides for batteries, methods of charging batteries, and charging systems.

In an aspect, the present disclosure provides for a battery comprising: an anode comprising a lithium-silicon compound, lithium-tin alloys, or lithium titanate (Li₄₊ₓTi₅O₁₂, where 0≤x≤3); a cathode comprising a lithium transition metal oxide or lithium transition metal phosphate; and an electrolyte; wherein the battery has the characteristic to be charged via a constant voltage only charging protocol, wherein the battery has the characteristic of being able to be charged to about 50% capacity in about 2-10 minutes.

In an aspect, the present disclosure provides for a method of charging a battery, comprising: charging a lithium ion battery using only constant voltage charging; wherein the lithium ion battery comprises an anode, a cathode, and an electrolyte; and wherein the anode comprises Li₄Ti₅O₁₂, wherein the lithium ion battery retains at least about 80% of battery capacity after 1000 charging cycles, wherein about 50% or more of charging capacity is achieved in about 2 to 10 minutes.

In an aspect, the present disclosure provides for a charging system, comprising: the lithium ion battery described in a previously described aspect; and a charger; wherein the charger is configured to charge the lithium ion battery using a constant voltage charging protocol; and wherein the charger is configured to not use a constant current protocol during charging.

Other batteries, systems, methods, features, and advantages of the present disclosure will be or become apparent to one with skill in the art upon examination of the following drawings and detailed description. It is intended that all such additional batteries, systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows constant voltage charging conditions evaluated.

FIG. 2 shows various metrics achieved using constant voltage (CV) charging.

FIG. 3 shows capacity retention of cells with various electrolytes.

FIG. 4 shows areal capacity and capacity retention after 1,000 cycles achieved from fast charge using CV.

FIG. 5 shows areal charge capacity as a function of charge time for CV charge.

FIG. 6 shows information extracted from P2D simulations of the charging process for CV charge at 2.8 V for 5 min.

FIG. 7 shows information extracted from P2D simulations of the charging process for CV charge at 3.8 V for 1 min.

FIG. 8 shows ionic conductivity as a function of LiPF₆ concentration in various solvents.

FIG. 9 shows first cycle charge and discharge voltage profiles for various cells.

FIG. 10 shows rate capability for various cells.

FIG. 11 shows a Nyquist plot from EIS on freshly made cells before cycling with various electrolytes.

FIG. 12 shows capacity as a function of cycle number for cells with Gen2 electrolyte and various CV charging conditions.

FIG. 13 shows Capacity as a function of cycle number for cells with EA electrolyte and various CV charging conditions.

FIG. 14 shows: Areal capacity achieved using CV fast charge for the different voltage and charging time conditions.

FIG. 15 shows quantitative values of the voltage associated with each overpotential source extracted from simulations at different state of charges for charging conditions at (a) 2.8 V for 5 min and (b) 3.4 V for 1 min.

FIG. 16 shows discharge areal capacity delivered during each cycle for 3000 charge/discharge cycles for cells with various electrolytes.

FIG. 17 shows discharge areal capacity delivered during each cycle for 1000 charge/discharge cycles for cells with various electrolytes.

FIG. 18 shows discharge areal capacity delivered during each cycle for 1000 charge/discharge cycles for cells with various electrolytes.

### DETAILED DESCRIPTION

Aspects of the present disclosure provide for lithium ion batteries, methods for charging lithium ion batteries, and charging systems comprising lithium ion batteries and a charger, where the lithium ion batteries can be charged at faster rates than previous devices. In particular, the charging is conducted using constant voltage (CV) as opposed to constant current (CC).

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

As used herein, the following terms have the meanings ascribed to them unless specified otherwise. In this disclosure, “comprises,” “comprising,” “containing” and “having” and the like can have the meaning ascribed to them in U.S. patent law and can mean “includes,” “including,” and the like; “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. patent law, allowing for the presence of more than that which is recited so long as basic or novel characteristics of that which is recited is not changed by the presence of more than that which is recited, but excludes prior art embodiments.

As used herein, the term “and/or” includes any and all combinations of one or more of the associated listed items. Expressions such as “at least one of,” when preceding a list of elements, modify the entire list of elements and do not modify the individual elements of the list.

Reference to “a” chemical compound refers to one or more molecules of the chemical compound rather than being limited to a single molecule of the chemical compound.

Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, the range includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y.’ The range can also be expressed as an upper limit, e.g., ‘about x, y, z, or less’ and should be interpreted to include the specific ranges of ‘about x,’ ‘about y,’ and ‘about z’ as well as the ranges of ‘less than x,’ less than y,’ and ‘less than z.’ Likewise, the phrase ‘about x, y, z, or greater’ should be interpreted to include the specific ranges of ‘about x,’ ‘about y,’ and ‘about z’ as well as the ranges of ‘greater than x,’ greater than y,’ and ‘greater than z.’ In addition, the phrase “about ‘x’ to ‘y’,” where ‘x’ and ‘y’ are numerical values, includes “about ‘x’ to about ‘y’.”

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise specified, temperatures referred to herein are based on atmospheric pressure (i.e. one atmosphere).

### A. DISCUSSION

The present disclosure provides for lithium ion batteries, methods for charging lithium ion batteries, and charging systems comprising lithium ion batteries and a charger. In an aspect, the lithium ion batteries can be charged at faster rates than previous devices. In particular, the charging is conducted using constant voltage (CV) as opposed to constant current (CC). In an aspect, the anode of the lithium ion battery is free of graphite or, in other words, graphite-free (e.g., the anode does not include graphite).

Constant voltage and constant current charging are two types of charging. Constant current (CC) charging is a battery charging method where a charger supplies a steady, fixed amount of current (commonly measured in amps or milliamps) into the battery. The voltage and resistance are then subject to fluctuation as the battery charges. Furthermore, constant voltage (CV) charging is a battery charging method where the voltage is held at a fixed amount or a near fixed amount and the current and resistance are subject to fluctuation. The batteries of the present disclosure are designed to have the characteristic of being able to be charged using a constant voltage, which allows the batteries to be charged very quickly (e.g., to about 50% or more in about 3 min, to about 70% or in about 5 min).

In an aspect, a lithium ion battery includes an anode, a cathode, and an electrolyte. The cathode is electrically connected to the anode via a circuit, and the lithium-ion containing electrolyte is in contact with the anode and the cathode. The batteries can be charged by directing current from a power supply, or charger, to the circuit. During charging, reduction occurs at the negative electrode, with electrons flowing from the cathode to the anode, and oxidation occurs at the positive electrode. In an aspect, the battery has the characteristic of preferably being charged using constant voltage (CV). This characteristic allows the battery to be charged very fast.

In an aspect, the battery can be charged to about 50% to 100%, about 50% to 90%, about 50% to 80%, about 50% to 70% in about 2 to 10 min, about 2 to 8 min, about 2 to 7 min, about 2 to 6 min, or about 2 to 5 min (e.g., any % range listed with any time frame listed). In an aspect, the battery can be charged to about 50% to 100%, about 50% to 90%, about 50% to 80%, about 50% to 70% in about 3 to 10 min, about 3 to 8 min, about 3 to 7 min, about 3 to 6 min, or about 3 to 5 min (e.g., any % range listed with any time frame listed). In an aspect, the battery can be charged to about 60% to 100%, about 60% to 90%, about 60% to 80%, about 60% to 70% in about 4 to 10 min, about 4 to 8 min, about 4 to 7 min, about 4 to 6 min, or about 4 to 5 min (e.g., any % range listed with any time frame listed). In an aspect, the battery can be charged to about 60% to 100%, about 60% to 90%, about 60% to 80%, about 60% to 70% in about 5 to 10 min, about 5 to 8 min, about 5 to 7 min, about 5 to 6 min, or about 5 min (e.g., any % range listed with any time frame listed). In an aspect, the battery can be charged to about 70% to 100%, about 70% to 90%, about 70% to 80%, about 70% in about 5 to 10 min, about 5 to 8 min, about 5 to 7 min, about 5 to 6 min, or about 5 min (e.g., any % range listed with any time frame listed). In an aspect, the battery can be charged to about 50% to 70% in about 2 to 7 min; about 50% to 70% in about 3 to 5 min; about 60% to 80% in about 4 to 7 min; about 60% to 80% in about 5 to 7 min; or about 60% to 70% in about 5 to 6 min.

The cathode can be made of or comprise one or more metal oxides. In an aspect, metal oxides can include lithium transition metal oxides or lithium transition metal phosphates. The cathode can be made of or comprise one or more lithium transition metal oxides such as: lithium cobalt oxide (LiCoO₂) (LCO); lithium manganese oxide (LiMn₂O₄) (LMO); lithium nickel manganese spinel (LiNi_{0.5}Mn_{1.5}O₄) (LMNO); lithium nickel cobalt aluminum oxide (LiNiCoAlO₂) (NCA); lithium nickel cobalt manganese oxide (LiNiCoMnO₂) (NMC); LiNiₓCo_{y}Mn_{z}, where x, y, and z can range from 0-1, and where x+y+z=about 1; other NMC's where a dopant can include Al, Ti, Mg, Zr, W, Y, Sr, F, Si, Na, Cu, Fe, Ca, S, B, V, Cr, Nb, and Mo (e.g., about 5% or less than 5% of the total cations are the dopant, about 0.05 to 5% of the total cations are the dopant, about 0.1 to 5% of the total cations are the dopant); and LiNi_{0.8}Co_{0.1}Mn_{0.1}O₂. A lithium transition metal oxide is a compound that includes lithium, oxygen, and one or more transition metals. In another aspect, the cathode can be made of or comprise one or more lithium transition metal phosphates such as: lithium iron phosphate (LiFePO₄) (LFP), lithium manganese phosphate (LiMnPO₄, LMP), lithium nickel phosphate (LiNiPO₄, LNP), lithium cobalt phosphate (LiCoPO₄, LCP), and blended phosphate phases including LiFeₓMn₍₁₋ₓ₎PO₄ (0<X<1) and LiNiₓCo₍₁₋ₓ₎PO₄ (0<X<1). A lithium transition metal phosphate is a compound that includes lithium, phosphate, and one or more transition metals. In a particular aspect, the cathode comprises LiNi_{0.8}Co_{0.1}Mn_{0.1}O₂. In an aspect, the amount of the metal oxide can be about 50 wt % to about 99 wt %, about 55 wt % to about 99 wt %, about 60 wt % to about 98 wt %, about 65 wt % to about 97 wt %, about 70 wt % to about 95 wt %, about 75 wt % to about 95 wt %, about 80 wt % to about 95 wt %, about 85 wt % to about 95 wt %, about 86 wt % to about 94 wt %, about 87 wt % to about 93 wt %, about 88 wt % to about 92 wt %, about 89 wt % to about 91 wt %, about 90 wt %, about 90 wt % to about 99 wt %, or about 85 wt % to about 99 wt %.

In an aspect, the cathode can also include a conductive carbon such as carbon black, carbon fibers, or graphene. The cathode can further comprise conductive carbon in an amount of about 0.1 wt % to about 20 wt %, about 0.1 wt % to about 15 wt %, about 0.1 wt % to about 10 wt %, about 1 wt % to about 9 wt %, about 2 wt % to about 8 wt %, about 3 wt % to about 7 wt %, about 4 wt % to about 6 wt %, about 5 wt %, or any other amount. The cathode can further comprise a binder in an amount of about 0.1 wt % to about 20 wt %, about 0.1 wt % to about 15 wt %, about 0.1 wt % to about 10 wt %, about 1 wt % to about 9 wt %, about 2 wt % to about 8 wt %, about 3 wt % to about 7 wt %, about 4 wt % to about 6 wt %, about 5 wt %, or any other amount. In a lithium ion battery, a binder serves to hold electrode materials together and conductive additives together. The binder secures active particles to each other and to current collectors. In an aspect, the binder comprises polyvinylidene fluoride (PVDF). The binder can also comprise styrene butadiene rubber (SBR), carboxymethyl cellulose (CMC), polyacrylic acid (PAA), polymethyl methacrylate (PMMA), polytetrafluoroethylene (PTFE), and polyvinylpyrrolidone (PVP).

The cathode can have a thickness of about 5 μm to about 100 μm, about 5 μm to about 90 μm, about 10 μm to about 80 μm, about 10 μm to about 70 μm, about 10 μm to about 60 μm, about 15 μm to about 55 μm, about 20 μm to about 50 μm, about 20 μm to about 40 μm, about 25 μm to about 35 μm, about 26 μm to about 35 μm, about 27 μm to about 35 μm, about 28 μm to about 35 μm, about 29 μm to about 35 μm, about 30 μm to about 34 μm, about 31 μm to about 33 μm, about 32 μm, or any other thickness. In an aspect, the cathode has a porosity of about 20 vol % to about 50 vol %, about 30 vol % to about 50 vol %, about 30 vol % to about 45 vol %, about 30 vol % to about 40 vol %, about 35 vol % to about 40 vol %, about 36 vol %, about 37 vol %, about 38 vol %, or any other porosity. Porosity, expressed in vol %, is the percentage of empty space, or voids, within a material's volume.

In an aspect, the anode can include materials such as lithium insertion materials or alloy host materials lithium-silicon compounds, lithium-tin alloys, and lithium titanate Li₄+Ti₅O₁₂, where 0≤x≤3, such as Li₄Ti₅O₁₂ (LTO). A lithium-silicon compound can include phases such as Li₁₃Si₄, Li₇Si₃, Li₁₂Si₇, Li₂₂Si₅, and others. An example of a lithium-tin alloy is Li₂₂Sn₅. In an aspect, the anode comprises Li₄Ti₅O₁₂. In another aspect, the anode can comprise one or more materials selected from Li₄Ti₅O₁₂, niobium oxide, titanium oxide, and molybdenum oxide. Titanium oxide can come in the form of TiNb₂O₇, or in another form. The amount of the material in the anode can be about 50 wt % to about 99 wt %, about 55 wt % to about 99 wt %, about 60 wt % to about 98 wt %, about 65 wt % to about 97 wt %, about 70 wt % to about 95 wt %, about 75 wt % to about 95 wt %, about 80 wt % to about 95 wt %, about 85 wt % to about 95 wt %, about 86 wt % to about 94 wt %, about 87 wt % to about 93 wt %, about 88 wt % to about 92 wt %, about 89 wt % to about 91 wt %, about 90 wt %, about 90 wt % to about 99 wt %, about 85 wt % to about 99 wt %, about 80 wt % to about 90 wt %, about 85 wt % to about 90 wt %, about 85 wt % to about 89 wt %, about 86 wt % to about 88 wt %, or about 87 wt %.

In an aspect, the anode can include a binder. The binder can be selected from polyvinylidene fluoride (PVDF) binder, styrene butadiene rubber (SBR), carboxymethyl cellulose (CMC), polyacrylic acid (PAA), polymethyl methacrylate (PMMA), polytetrafluoroethylene (PTFE), and polyvinylpyrrolidone (PVP). The anode can further comprise a binder in the amount of about 0.1 wt % to about 20 wt %, about 0.1 wt % to about 15 wt %, about 0.1 wt % to about 10 wt %, about 5 wt % to about 15 wt %, about 1 wt % to about 10 wt %, about 2 wt % to about 10 wt %, about 3 wt % to about 10 wt %, about 4 wt % to about 10 wt %, about 5 wt % to about 10 wt %, about 6 wt % to about 10 wt %, about 7 wt % to about 9 wt %, or about 8 wt %.

The anode further can comprise conductive carbon (e.g., carbon black, carbon fibers, or graphene) in an amount of about 0.1 wt % to about 20 wt %, about 0.1 wt % to about 15 wt %, about 0.1 wt % to about 10 wt %, about 1 wt % to about 9 wt %, about 2 wt % to about 8 wt %, about 3 wt % to about 7 wt %, about 4 wt % to about 6 wt %, about 5 wt %, or any other amount. The anode has a thickness of about 5 μm to about 200 μm, about 10 μm to about 200 μm, about 10 μm to about 150 μm, about 20 μm to about 150 μm, about 20 μm to about 100 μm, about 30 μm to about 90 μm, about 40 μm to about 80 μm, about 50 μm to about 70 μm, about 55 μm to about 70 μm, about 60 to about 65 μm, about 63 μm, or any other thickness. The anode has a porosity of about 15 vol % to about 50 vol %, about 20 vol % to about 40 vol %, about 25 vol % to about 35 vol %, about 30 vol % to about 35 vol %, or about 32 vol %.

In an aspect, the electrolyte can include a lithium salt. In an aspect, the lithium salt can include: lithium perchlorate (LiClO₄), lithium tetrachloroaluminat (LiAlCl₄), lithium iodate (Lil), lithium bromide (LiBr), lithium bis(oxalato)borate (LiB(C₂O₄)₂), lithium bis(oxalato)borate (LiBOB), (LiBF₂(C₂O₄)), lithium difluoro(oxalato)borate (LiODFB), lithium thiocyanate (LiSCN), lithium tetrafluoroborate (LiBF₄), lithium tetraphenylborate tris(1,2-dimethoxyethane) (LiB(C₆H₅)₄) lithium hexafluoroarsenate (LiAsF₆), lithium triflate (LiCF₃SO₃), LiN(FSO₂)₂, lithium bis(fluorosulfonyl)imide (LiFSI), lithium bis(trifluoromethanesulfonimide) (LiN(CF₃SO₂)₂), lithium bis(trifluoromethanesulfonyl)imide (LiTFSI), lithium hexafluorophosphate (LiPF₆), lithium tetrafluorooxalatophosphate (LiPF₄(C₂O₄)), lithium tetrafluorooxalatophosphate (LiFOP), lithium nitrate (LiNO₃), and mixtures thereof. The electrolyte can include the lithium salt mixed with an organic solvent or mixture of organic solvents. In an aspect, the solvent can an organic carbonate, such as ethylene carbonate, propylene carbonate, dimethyl carbonate, diethyl carbonate, and ethyl methyl carbonate; as well as, for example, ethers, esters, and nitriles (e.g., acetonitrile). Exemplary ethers include, but are not limited to, dimethoxyethane, diethoxyethane, dibutoxyethane, diglyme (i.e., diethylene glycol dimethyl ether), triglyme (i.e., triethylene glycol dimethyl ether), tetraglyme (i.e., tetraethylene glycol dimethyl ether), tetrahydrofuran, 2-methyltetrahydrofuran, 2,5-dimethyltetrahydrofuran, 1,3-dioxolane, and 4-methyl-1,3-dioxolane. In some embodiments, the solvent can be acetonitrile, dimethylacetamide, diethyl carbonate, dimethyl carbonate (DMC), y-butyrolactone (GBL), propylene carbonate (PC), ethylene carbonate (EC), N-methyl-2-pyrrolidone (NMP), fluoroethylene carbonate, N,N-dimethylacetamide, and mixtures thereof. In one aspect, the electrolyte comprises lithium salt (e.g., LiPF₆) ethyl acetate, methyl acetate, propyl acetate, ethyl formate, ethyl methyl carbonate, ethylene carbonate, 1,2-dimethoxyethane, and mixtures thereof. The solvent mixture can include two or three solvents from about 5 to 80 of each solvent. In an aspect, the electrolyte comprises a weight ratio of 7:3 of the LiPF₆ in ethyl methyl carbonate to the ethylene carbonate.

In an aspect, the battery can have an anode on an Al current collector and a cathode on an Al current collector. A current collector is a conductive material that supports the electrode materials and can transport electrons between the electrodes and external circuits during charge/discharge cycles. The electrodes can have a nominal capacity of about 1.5 mAh cm⁻². In an aspect, the electrodes are separated by a porous polyolefin separator. The battery can be charged using a constant voltage charging protocol, and a charge state of 70% can be achieved in 5 minutes of charging.

The lithium ion battery can have an areal capacity of about 1 mAh cm⁻² to about 2.5 mAh cm⁻², about 1 mAh cm⁻² to about 2 mAh cm⁻², or about 1.5 mAh cm⁻². The areal capacity of a battery is the amount of charge a battery electrode can hold per unit of its geometric surface area. The areal capacity can vary depending on targeted loading, and thickness of electrodes. The anode has an open circuit potential of about 1.56 V vs. Li/Li⁺.

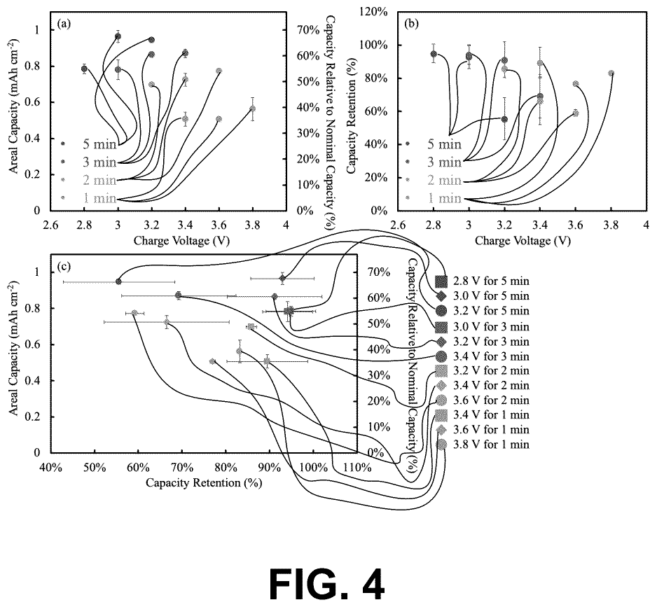

In an aspect, the disclosure provides for a method of charging a battery. The method comprises charging a lithium ion battery using only constant voltage (CV) charging. The method provides that Li plating does not occur during charging of the lithium ion battery. Lithium plating in a battery is when lithium ions deposit as solid, metallic lithium onto the anode surface instead of inserting into the anode's structure. Using the charging method, the lithium ion battery retains at least about 80% of battery capacity after 1000 charging cycles. Furthermore, using the charging method results in greater than at least about 50% charging capacity in less than 3 minutes of charging or about 70% charging capacity in less than 5 minutes. See FIG. 4 for charge voltages used to achieve particular charging capacities.

In an aspect, the disclosure provides for a lithium ion battery comprising an anode, a cathode, and an electrolyte as described above and herein. The lithium ion battery has the characteristic to be charged via a constant voltage only charging protocol. This means that only constant voltage will be used to charge the lithium ion battery, and constant current will not be used. In another aspect, the disclosure provides for a method of charging the lithium ion battery described in the aspect above, using only a constant voltage charging protocol.

The disclosure also provides for a charging system. The charging system comprises a lithium ion battery, such as one described above, and a charger. The charger is configured to charge the lithium ion battery using only a constant voltage charging protocol, meaning that a constant current protocol is not used for charging. An example of a charger that can be used is a potentiostat or power supply that can be held at constant potential and deliver the maximum current supplied by the cell once the charging is initiated. A charger can be configured to provide constant voltage charging through pre-programming using software that controls the operation of the charger, or by a manual operation. Furthermore, the charger is configured to charge the lithium ion battery to at least 70% in under 5 minutes for the highest rate charging conditions evaluated for the cell.

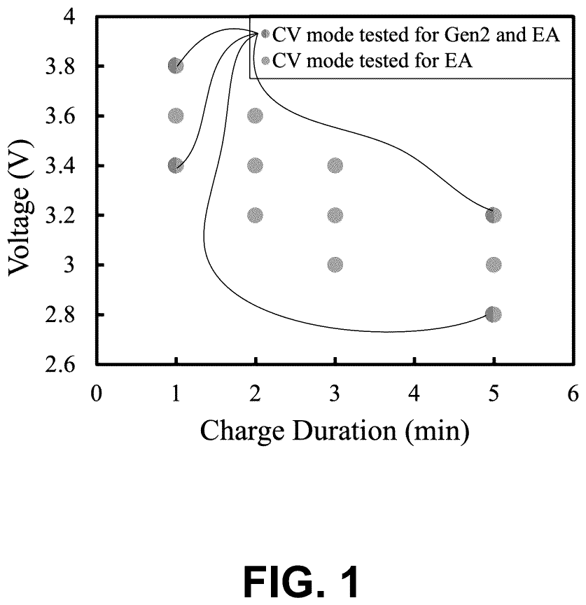

With reference to FIGS. 1-15, see the Examples section below for an explanation of each figure.

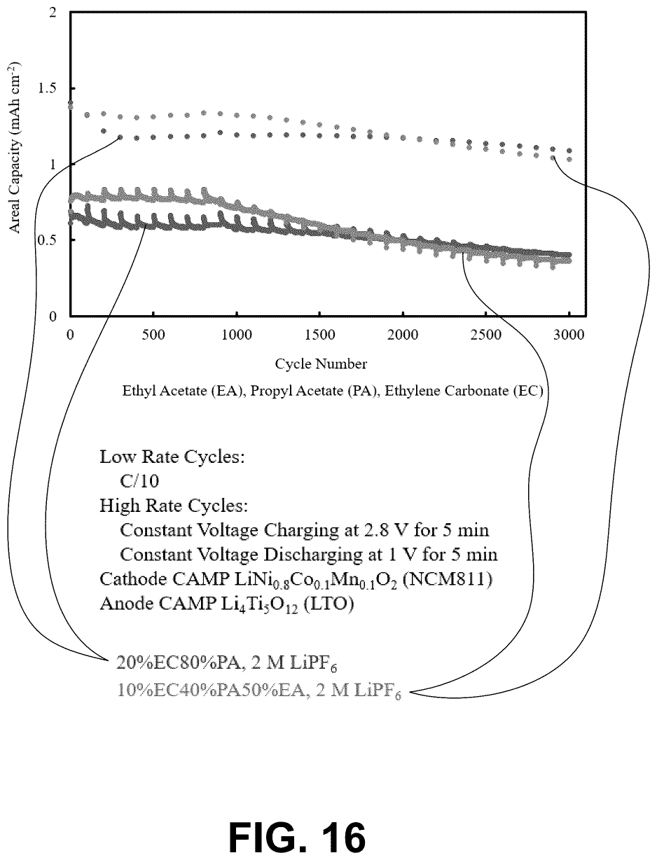

With reference to FIG. 16, shown is: Discharge areal capacity delivered during each cycle for 3000 charge/discharge cycles for cells with electrolytes of 2 M LiPF₆ with solvents of 20% ethylene carbonate and 80% propyl acetate (dark grey) and 10% ethylene carbonate, 40% propyl acetate, and 50% ethyl acetate (light grey). Every 100 cycles included an initial cycle with low rate CC charge and discharge at C/10, followed by 99 cycles with high rate CV charge and discharge. Anode material was Li₄Ti₅O₁₂ (LTO) and cathode material was LiNi_{0.8}Co_{0.1}Mn_{0.1}O₂(NCM811).

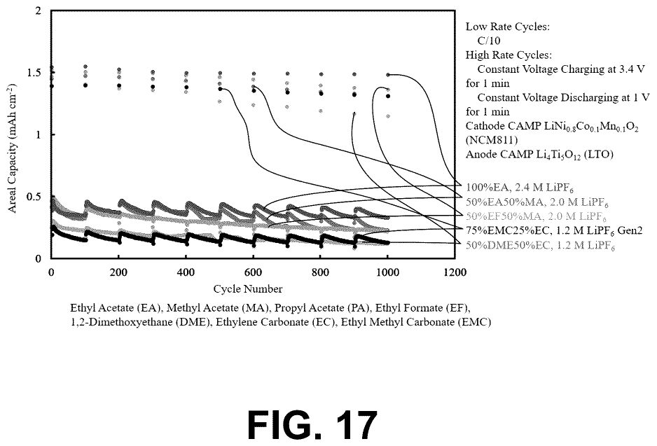

With reference to FIG. 17, shown is: Discharge areal capacity delivered during each cycle for 1000 charge/discharge cycles for cells with electrolytes of: 2.4 M LiPF₆ with solvent of 100% ethyl acetate (purple); 2.0 M LiPF₆ with solvents of 50% ethyl acetate and 50% methyl acetate (blue); 2.0 M LiPF₆ with solvents of 50% ethyl formate and 50% methyl acetate (orange); 1.2 M LiPF₆ with solvents of 75% ethyl methyl carbonate and 25% ethylene carbonate (black); 1.2 M LiPF₆ with solvents of 50% 1,2-dimethoxyethane and 50% ethylene carbonate (grey). Every 100 cycles included an initial cycle with low rate CC charge and discharge at C/10, followed by 99 cycles with high rate CV charge and discharge. Anode material was Li₄Ti₅O₁₂ (LTO) and cathode material was LiNi_{0.8}Co_{0.1}Mn_{0.1}O₂(NCM811).

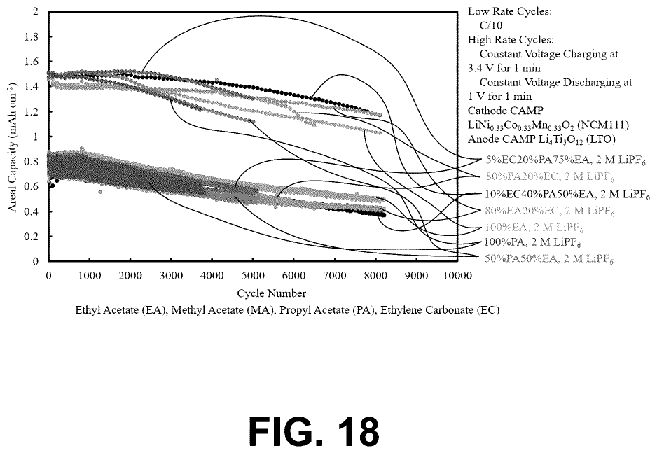

With reference to FIG. 18, shown is: Discharge areal capacity delivered during each cycle for up to 8000 charge/discharge cycles for cells with electrolytes of: 2.0 M LiPF₆ with solvent of 5% ethylene carbonate, 20% propyl acetate, and 75% ethyl acetate (brown); 2.0 M LiPF₆ with solvents of 80% propyl acetate and 20% ethylene carbonate (orange); 2.0 M LiPF₆ with solvents of 10% ethylene carbonate, 40% propyl acetate, and 50% ethyl acetate (black); 2.0 M LiPF₆ with solvents of 80% ethyl acetate and 20% ethylene carbonate (green); 2.0 M LiPF₆ with solvents of 100% ethyl acetate (blue); 2.0 M LiPF₆ with solvents of 100% propyl acetate (purple); 2.0 M LiPF₆ with solvents of 50% propyl acetate and 50% ethyl acetate (red). Every 100 cycles included an initial cycle with low rate CC charge and discharge at C/10, followed by 99 cycles with high rate CV charge and discharge. Anode material was Li₄Ti₅O₁₂ (LTO) and cathode material was LiNi_{0.33}Co_{0.33}Mn_{0.33}O₂(NCM111).

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### B. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in °C or is at ambient temperature, and pressure is at or near atmospheric.

### 1. Example 1

### Constant Voltage Fast Charge Evaluation of Lithium-Ion Battery Full Cells.

### Abstract.

Lithium (Li)-ion batteries provide rechargeable power options for broad applications that require high energy density. Conventional graphite anodes achieve high energy density, but operate at voltages where under fast charging conditions Li plating can initiate. Carbonate solvents generally coupled with graphite anodes also have relatively high viscosity which limit transport capabilities and charging rates for Li-ion cells. Li₄Ti₅O₁₂ (LTO) anode material, despite lower energy density compared to graphite, has high cycling stability and operating voltage far from Li plating and electrolyte reduction. LTO is also compatible with a broader range of electrolyte solvents with low viscosity and improved transport properties. Herein, full cells with moderate loading of ~1.5 mAh cm⁻² and LiNi_{0.8}Co_{0.1}Mn_{0.1}O₂ cathodes paired with LTO anodes were evaluated for fast charge capabilities using constant voltage charging. The constant voltage charging was a very time efficient method for charging the cells, while maintaining cycle life. The constant voltage fast charging was also assessed in context of pseudo-two-dimensional simulations, and interfacial kinetics and ion transport in the electrolyte phases were identified as the most significant factors limiting achieving higher states of charge during the charging process.

### Introduction

Lithium (Li)-ion batteries provide power to wide applications, including portable devices, wearable electronics, and electric vehicles [1-4]. Recently, there have been efforts towards understanding and improving the fast charge capabilities of Li-ion cells, including electrolyte composition modifications [5,6], electrode architecture engineering [7-9], electroactive material chemistry [10-14], and local temperature control [15]. Graphite has been used as the anode material in many cases due to relatively low cost, lithiation/delithiation stability, and high energy density [16,17]. However, graphite is inherently vulnerable in fast charge applications because the open circuit potential (OCV) across a large extent of its range of lithiation is very close to Li metal (<0.2 V, vs. Li/Li⁺), which can lead to the side reactions of Li dendrite deposition and excess solid-electrolyte interface (SEI) formation, resulting in irreversible capacity fade and in some cases safety challenges [16,17]. An alternative commercial anode material, Li₄Ti₅O_{1z}(LTO), has an OCV of ~1.56 V (vs. Li/Li⁺), which is far from Li plating and many SEI reactions [18]. Importantly, although there is a sacrifice with regards to energy and power density due to net reduction of cell voltage, the narrower operating voltage window opens up new opportunities for the use of alternative low viscosity solvents such as esters. Esters have much lower viscosity than cyclic carbonates, which have relatively high viscosity but are generally necessary for formation of a stable SEI layer on graphite anodes [5].

To charge conventional Li-ion cells with graphite anodes, various charging protocols have been employed. Perhaps the most common is a constant current (CC) current charge to a cutoff voltage, followed by constant voltage (CV) held at that cutoff voltage until a particular low current threshold is achieved. Other methods such as current pulsing, multi-stage current, and constant power have also been reported [19]. There are many considerations for decisions on the optimal charging profile, given different targeted outcomes such as limiting the onset of Li plating, limiting the maximum cell temperature, and avoiding overcharge [19]. To the best our knowledge, a simple CV charging mode has not received significant investigation for Li-ion cells, likely due to the limitations of using only CV charging with graphite anodes. Herein, this work investigates CV charging of Li-ion cells with LTO anodes. As a preliminary proof of concept, coin cells were used and two electrolytes were explored, both a more conventional carbonate-based electrolyte and an electrolyte with ethyl acetate (EA) solvent. CV charging shows promise in charging cells at very high rates, with high retention of capacity with cells that have LTO anodes. The CV charging outcomes will also be discussed in the context of CV charging simulations.

### Materials and Methods

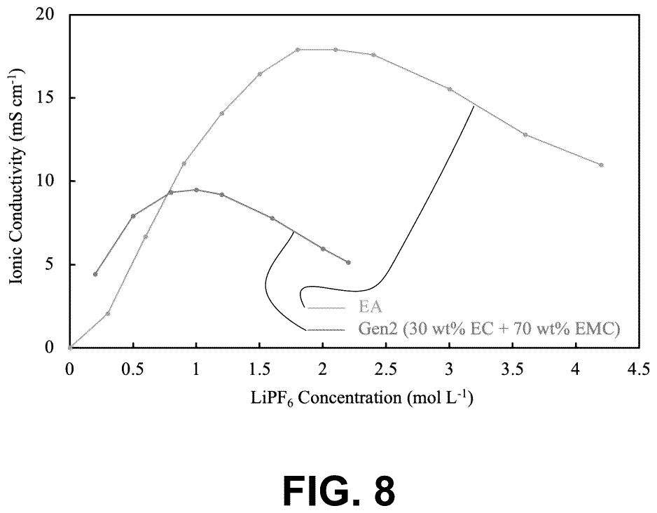

LTO and LiNi_{0.8}Co_{0.1}Mn_{0.1}O₂(NCM811) electrodes were received from Cell Analysis, Modeling, and Prototyping Facility (CAMP) at Argonne National Lab. The anode contains 87 wt % LTO from NEI Corporation, 5 wt % conductive carbon, and 8 wt % Polyvinylidene fluoride (PVDF) binder. The anode thickness was 63 μm with porosity of 32 vol %. The cathode was composed of 90 wt % NCM811 from Targray, 5 wt % conductive carbon, and 5 wt % PVDF binder. The cathode thickness was 32 μm with porosity of 37 vol %. The electrodes were punched into circular discs with diameters of 13 mm, dried at 110 °C for 1 hour under vacuum, and transferred into an argon-filled glove box (<1 ppm H₂O and O₂). Two major electrolyte compositions were evaluated: 1.2 M LiPF₆ in ethyl methyl carbonate:ethylene carbonate (EMC:EC) with 7:3 ratio by weight (Gen2, from Gotion), and 2.4 M LiPF6 (from Gotion) in ethyl acetate (EA, Acros Organics). In addition, a 2.4 M LiPF6 in EMC:EC with 7:3 ratio by weight (referenced as “Gen2H”) and 1.2 M LiPF₆ in EA (referenced as “EAL”) were also prepared to provide insights into the relative impact of salt concentration on fast charge capability (matching the solute concentration for each of the other solvent electrolyte systems). Detailed ionic conductivity measurements for these electrolytes can be found in previous reports [5,20], and also can be found in Supporting Information, FIG. 8. Circular Celgard 2325 separators with diameters of 18 mm were punched out and used between the anode and cathode discs for all cells, with the exception of those with Gen2H. For cells with Gen2H electrolyte, Celgard 3041 had to be used as the separator because that electrolyte would not wet the Celgard 2325. Half cells were fabricated using LTO or NCM811 as cathodes and pairing them with Li metal anodes in 2032-type coin cells. LTO half cells were discharged to 1.0 V and charged back to 2.5 V at 0.075 mA cm⁻² (~C/20); NCM811 half cells were charged to 4.4 V and discharged back to 2.5 V at 0.075 mA cm⁻² (~C/20). Full cells were fabricated into 2032-type coin cells using LTO as anodes and NCM811 as cathodes. Cells were also assessed using more conventional CC charge/discharge cycling. For CC cycling, cells were cycled using a voltage window of 1-3 V (cell), with cycling C-rates increasing from C/10 to 10 C. Full cells before cycling were also evaluated with electrochemical impedance spectroscopy (EIS) using Gamry Reference 600 potentiostat.

The constant voltage cycling procedures for the full cells were as follows: The 1st cycle was a relatively slow CC cycle at 0.15 mA cm⁻² (~C/10) between 1.0-3.2 V. Then, the next 99 cycles were conducted using CV only for both charge and discharge. The process was then repeated for every 100 cycles (a single slow CC charge and discharge followed by 99 CV charge and discharge cycles). All discharge CV cycles were conducted at 1.0 V (cell). The Gen2 and EA cells were evaluated using four different CV charge conditions, where only a single condition was applied to a given cell: 2.8 V for 5 min, 3.2 V for 5 min, 3.4 V for 1 min, and 3.8 V for 1 min. There were additional CV modes tested for EA cells with more intermediate charging voltages and durations because that electrolyte demonstrated higher capacity across the different charging conditions. The CV charging conditions are summarized in FIG. 1. All cell conditions shown in FIG. 1 were fabricated and assessed in duplicate. We chose to use shorter charging duration for the higher voltage CV modes, because the thermodynamically stable voltage window is no greater than ~3.2 V (assuming 1.0 V vs. Li/Li⁺, 4.3 V vs. Li/Li⁺ for NCM811, and an extra 0.1 V for anode-cathode capacity balancing). Above the stability window, we reduced the charge time to mitigate possible side reactions such as over-lithiation of LTO, SEI formation on LTO, or over-delithiation of the NCM811.

FIG. 1: Constant voltage charging conditions evaluated in this work. Red/blue blend dots represent conditions assessed for both electrolytes, while the blue dots represent the conditions only evaluated for the EA electrolyte.

A pseudo-two-dimensional (P2D) simulation framework based on Newman's original work was used for charge simulations [21,22]. The simulation implemented implicit numerical methods. The constant voltage was realized by solving the current at each time step. Detailed model equations can be found in Supporting Information, and parameters are listed in Supporting Information, Tables S1 and S2. Overpotential distributions, including relative contributions from interfacial kinetics, electrolyte ionic overpotential, electrode electronic overpotential, and OCV inhomogeneity, were calculated using methods described in priorwork [23]. Only Gen2 cells were assessed using simulation because insufficient electrolyte properties were available to have confidence in the results for the EA electrolyte [20].

### Results and Discussion

### Conventional Electrode/Electrolyte Evaluation.

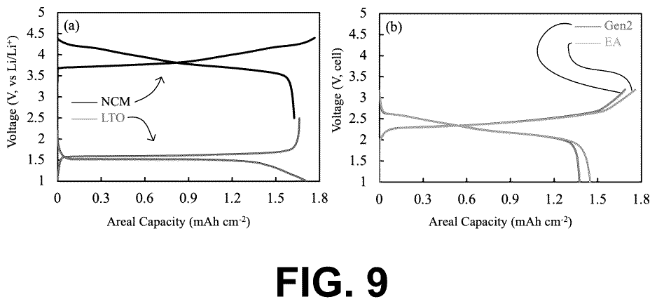

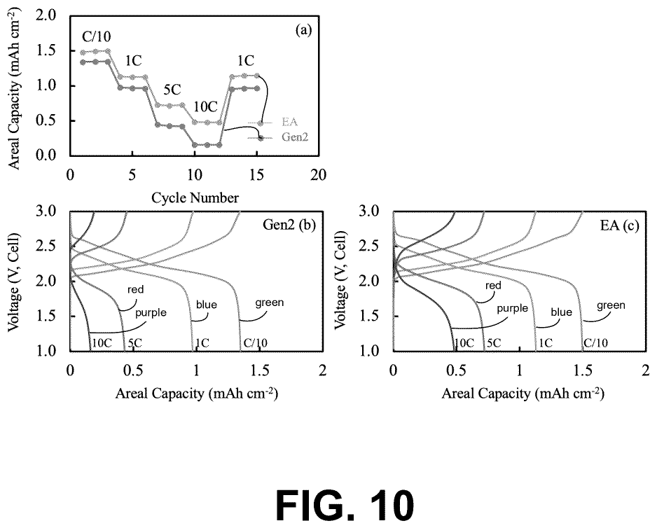

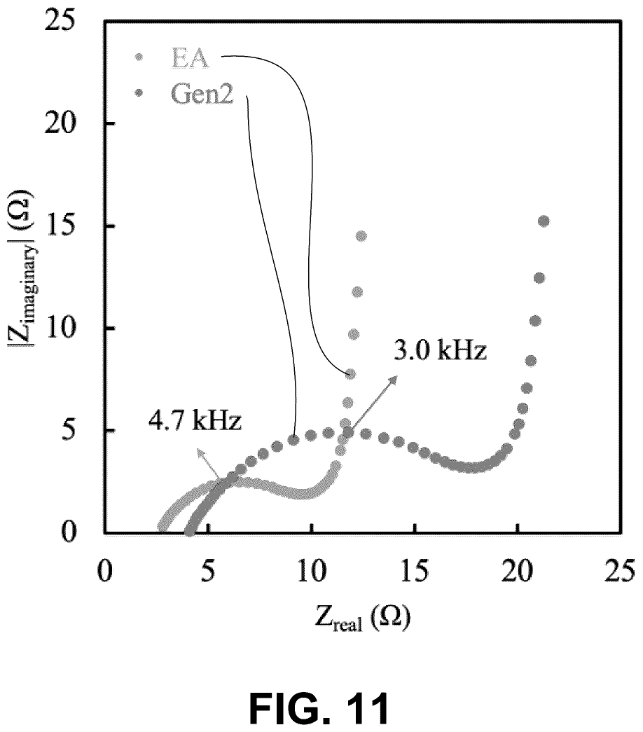

The voltage profiles for the first cycle for LTO and NCM811 half cells can be found in Supporting Information, FIG. 9a. Both electrodes delivered areal capacities of over 1.5 mAh cm⁻². In full cells, the first slow cycle at C/10 charge and discharge at voltage window of 1.0-3.2 V for all cells fabricated delivered ~1.4 mAh cm⁻², and exemplar voltage profiles for full cells with both Gen2 and EA electrolytes can be found in Supporting Information, FIG. 9b. The voltage profiles for the full cells with the two different electrolytes were similar, although the EA electrolyte cells had slightly higher capacity. Conventional CC cycling was also conducted with voltage limits of 1-3 V (cell). The rate capability outcomes can be found in Supporting Information, FIG. 10a, and exemplar voltage profiles can be found in Supporting Information, FIGS. 10b-c. At 5 C and 10 C, the EA cell had 70% and 200% more capacity than the Gen2 cell, which further supports the transport advantage of EA electrolyte. The Nyquist plot of Gen2 and EA cells before cycling can also be found in Supporting Information, FIG. 11. Differences in the high frequency intercept would be expected to reflect differences in the ionic conductivity of the electrolyte impregnated in the separator, because all other cell components were the same and the high frequency current pathway would be expected to take a less resistive electronic pathway for every other contribution to the high frequency intercept with the exception of the separator region. The high frequency intercept for the EA cell was 2.6) and Gen2 cell was 4.1 D, also consistent with ionic conductivity of the electrolytes for those cells.

CV Cycling with Both Electrolytes.

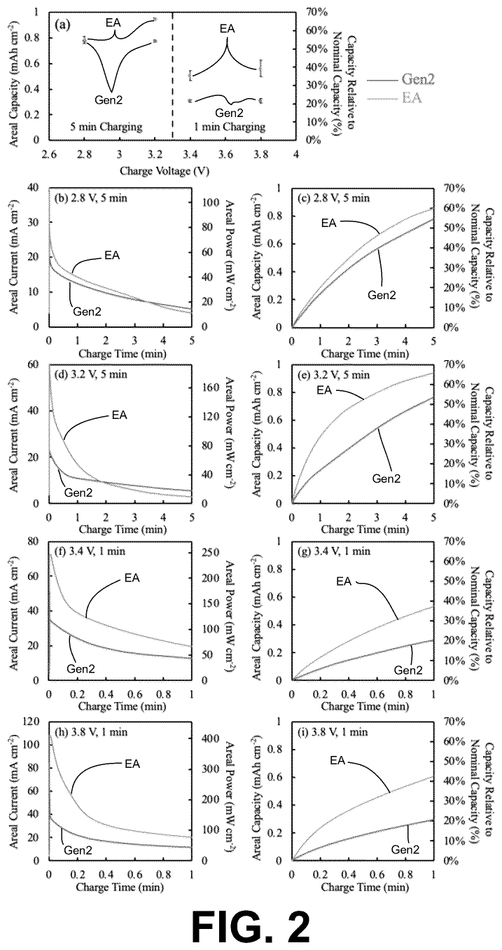

After the first C/10 slow cycle, the cells were charged with CV. The areal capacity achieved by Gen2 and EA electrolytes with the different combinations of charging voltage and time initially assessed can be found in FIG. 2a. The conditions evaluated were charging for 5 min at 2.8 V, 5 min at 3.2 V, 1 min at 3.4 V, and 1 min at 3.8 V. The data reported includes duplicate cells for each electrolyte and charging condition, with reported standard deviations based on those duplicates. Cells with both EA and Gen2 electrolytes achieved nearly 0.8 mAh cm⁻² when charged at 2.8 V for 5 mins; charging at a higher voltage of 3.2 V for same amount of time resulted in increased capacity for EA to nearly 1 mAh cm⁻² (~70% of the nominal capacity) but did not increase the capacity of cells with Gen2 electrolyte. When charging at much higher voltage (3.4 V and 3.8 V) for shorter duration of 1 min, the EA cells achieved capacity of 0.34 and 0.40 mAh cm⁻², both higher capacities than the cells with Gen2 electrolyte cells with equivalent charging conditions by over 50%. It is noted here that charging for 1 min at 3.8 V delivered over 40% the nominal capacity to the cell.

FIG. 2: (a) Areal capacity achieved using CV fast charge for the 4 different voltage and charging time conditions indicated on the figure (b, d, f, and h) Areal current and power and (c, e, g, and i) areal capacity as a function of charge time. Exemplar profiles for CV charging conditions of (b, c) 2.8 V for 5 min, (d, e) 3.2 V for 5 min, (f, g) 3.4 V for 1 min, and (h, i) 3.8 V for 1 min. For all plots in the figure, results for cells with Gen2 electrolyte are red and with EA electrolyte are blue.

Exemplar profiles of areal current and capacity charged as a function of charging time for the different charge voltages and durations are shown in FIG. 2b-i. At 2.8 V for 5 min, the maximum current observed for the EA cell was about 25 mA cm⁻², which was ~30% greater than that achieved for the cells with Gen2 electrolyte. At 3.2 V for 5 min, the EA cell peak current was 60 mA cm⁻², achieving 100% more than the Gen2 cell. At 3.4 V and 3.8 V for 1 min, the peak current of EA achieved 72 mA cm⁻² and 108 mA cm⁻² (those peak currents being equivalent to C-rates of 50 C and 75 C), all exceeding >2× of the Gen2 cells. While as will be discussed later the overpotentials can have significant contributions from multiple factors, it would be expected that the maximum current would in many cases be limited by the transport properties of the electrolyte. While all of the transport properties for the EA electrolyte have not been reported to the level of detail of the Gen2 electrolyte, it is noted that the peak conductivity of the EA electrolyte is over 17 mS cm⁻¹, while the Gen2 peak conductivity is 9 mS cm⁻¹ [5,20]. The improved transport properties of the EA electrolyte thus increase the currents that can be achieved during CV charging, and the rate of increase in charging capacity within the battery.

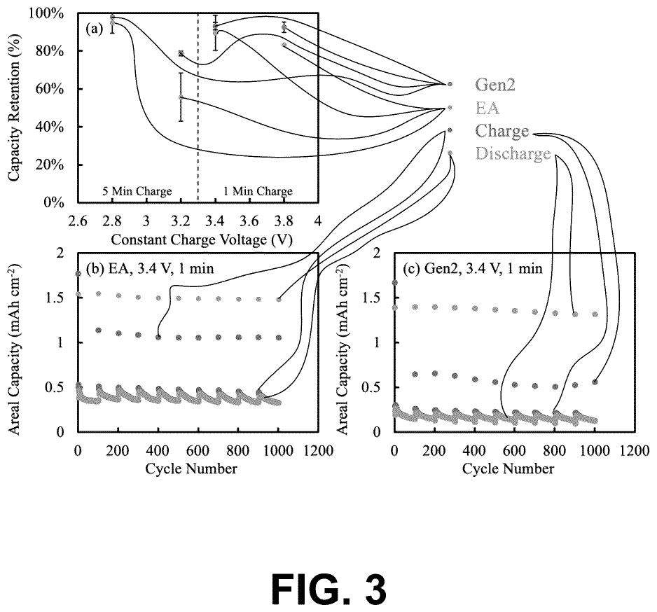

While the CV charging described above resulted in promising fast charging outcomes, another important consideration with fast charging of Li-ion cells is the capacity fade with cycling [24]. The aggressive fast charge cycling can drive a number of undesirable side reactions within the cells, which can result in accelerated capacity fade. At least from a cycle life perspective, the CV charge and discharge cycling provided a time efficient method to assess the cells after 1,000 charge and discharge cycles primarily using the CV fast charge and discharge protocol. The capacity retentions for the 4 charging conditions above, after 1000 cycles (where every 100 cycles included 99 CV cycles and 1 CC cycle as described earlier), can be found in FIG. 3. The summary capacity retention in FIG. 3a was calculated by taking the ratio of the 1001^{st} discharge capacity divided by the 1^{st} discharge capacity (both of these were relatively slow CC cycles). The capacities delivered between CC cycles (e.g., the intermediate 99 CV cycles) were lower due to the much higher rates of charge. For the same CV voltage and time, all the EA cells had lower capacity retentions than Gen2, where the difference was most pronounced for the cell that had CV charging conditions of 3.2 V for 5 mins for each CV charge cycle.

FIG. 3: (a) Capacity retention of cells with Gen2 (red) or EA (light blue) electrolyte with the indicated CV charging conditions. The retention was based on the discharge capacity of 1001^{st} discharge cycle relative to the 1^{st} discharge cycle (both were low rate CC cycles). Exemplar charge (blue dots) and discharge (orange dots) areal capacity during cycle life evaluation for cells with (b) EA and (c) Gen2 electrolyte using the 3.4 V 1 min CV charge outcomes. Every 100 cycles included an initial cycle with CC charge and discharge at C/10, followed by 99 cycles were CV charge and discharge.

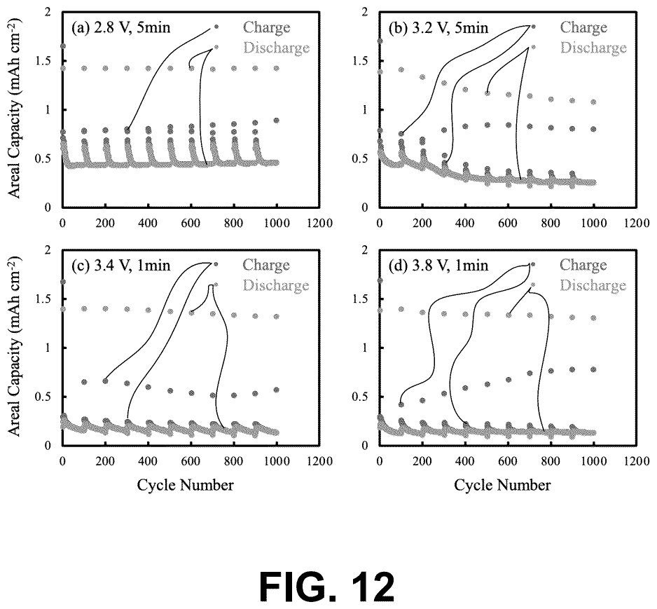

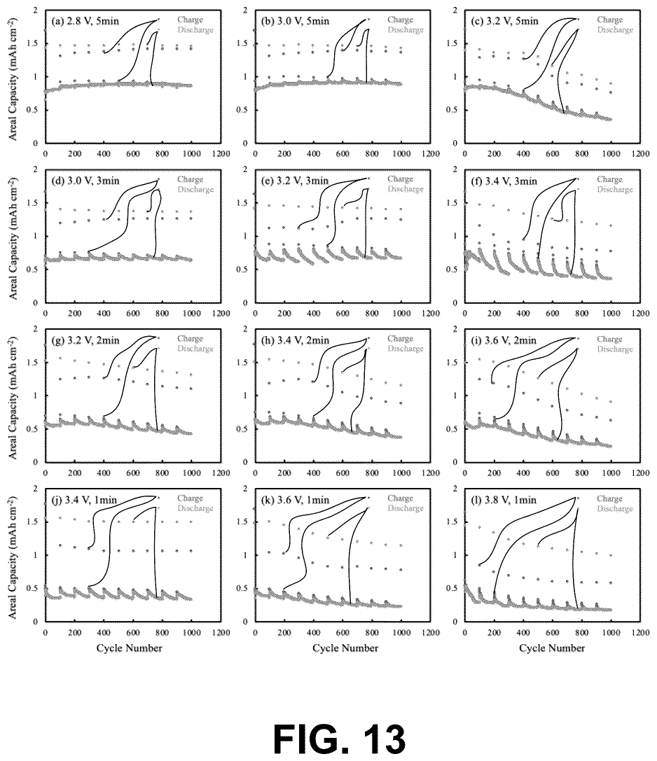

While the Gen2 electrolyte had slightly higher capacity retention, the much higher charge capacity for the EA electrolyte motivated investigation of additional intermediate CV conditions with regards to the applied charging voltage and charging time to assess the impacts of the charging procedure on the charge capacity and cell cycling stability. FIG. 4 summarizes the areal charge capacity and capacity retention after 1,000 cycles for the 12 CV charge conditions assessed for cells with EA electrolyte. For short charge time of 1 min, the areal capacity remained relatively low at ~0.6 mAh cm⁻² regardless if the applied voltage driving force was increased. However, higher voltage still influenced the cycle life, where cycle stability decreased for higher voltage CV even for the short 1 min charge duration. It is noted here that this charging protocol forced many charge cycles using the aggressive fast charge CV process—it is less clear in an application that could accommodate a variety charging conditions and less frequently needed the fast charge capability how the cycle life retention would translate. In any case, many of the conditions had encouraging cycle life retention, with 7 of the 12 CV charge conditions retaining >80% capacity after 1,000 cycles. FIG. 4c consolidates the information from FIGS. 4a and 4b into a single plot, where the right corner is the region with both higher charge capacity and cycle stability. Charging at 3.0 V for 5 min, 3.2 V for 3 min, 3.0 V for 3 min, and 2.8 V for 5 min were the most promising conditions which balanced both charge capacity and cycle stability. Additional cycle life and current rate data can be found in Supporting Information, FIG. 12 and FIG. 13.

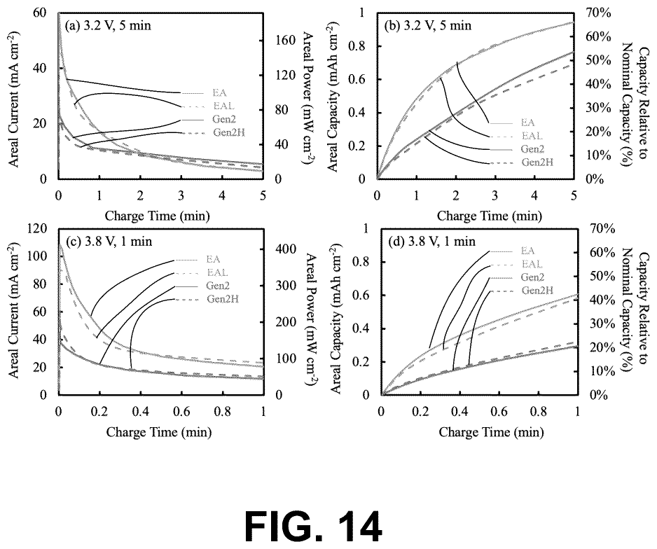

Additional fast CV charging tests were performed on cells using Gen2H (Gen2 with higher LiPF₆ concentration, at the same molarity as the peak conductivity in the EA electrolyte) and EAL (EA with lower concentrations, matching the molarity of the Gen2 electrolyte). Exemplar current and capacity profiles as a function of charge time can be found in Supporting Information, FIG. 14. Examining the ionic conductivity of Gen2 as a function of LiPF₆ concentration (Supporting Information, Figure S1), at the prepared 2.4 M the conductivity had dipped below 5 mS cm⁻¹. With higher initial LiPF₆ concentration, the concentration gradient would be greater between anode and cathode, thus providing a greater driving force for ion diffusion. However, during preparation the electrolyte became very viscous which would be expected to negatively affect ion transport. 3.2 V for 5 min and 3.8 V for 1 min CV conditions were chosen to assess the cells as the fast charge rate capability was more of interest at the higher voltage driving force conditions. The Gen2H cell charged at 3.2 V for 5 min had a similar current density as a function of time profile to the Gen2 cell, although the areal current was slightly lower. At 3.8 V for 1 min, the areal current and capacity for Gen2H was again similar to but slightly lower than the Gen2 cell, and in any case despite the same solute concentration was much lower than the EA cells. Similarly, the EAL (with lower concentration matched to the molarity of Gen2) cell charged at 3.2 V for 5 min had similar profile but slightly lower capacity and current density compared to the EA cells, and the decrease in current density and relative capacity and current density was a bit more pronounced than the EA cells for the 3.8 V for 1 min CV process. These cells led to the conclusion that the ionic conductivity due to the solvent selection was a greater driver of CV charging current density and capacity capabilities relative to the total initial LiPF₆ concentration.

### Benchmarking & Envisioning.

To the best of our knowledge, reports of fast charge for Li-ion batteries with few minutes-scale charge duration, high cycle life, and moderate loading/porosity are not common. Wang et al reported a monodisperse nano-LTO based anode that achieved ~60% the nominal capacity at 80 C and capacity retention above 90% after 500 cycles at 10 C, although the loading was relatively low at 2.0 mg cm⁻² (or equivalently 0.34 mAh cm⁻²) [25]. Mu et al reported a carbon coated LTO anode that achieved 75% of the nominal capacity at 80 C and capacity retention of 60% after 200 cycles, although this was also at relatively low loading of 1.4 mg cm^{-2 [26}]. Zhao et al reported a 3D nanoarchitectured LTO that achieved 60% the nominal capacity at 1000 and no noticeable capacity fade after 1000 cycles at 50 C, also with a loading of 1.4 mg cm⁻² [27]. Liu et al leveraged a 3d printing method and fabricated higher loading LTO electrodes with loadings of 13 (similar to this work), 24, and 32 mg cm⁻² and porosities above 65%. The charging capacity was ~67%, ~37%, and ~27% of nominal capacity charged at 5 C (highest reported rate), with the lower rate consistent with the tradeoffs at higher loading [28]. Jaiswal et al reported a full cell with LiFePO₄ (LFP) cathode and LTO anode with a loading of ~1.1 mAh cm⁻² (75% of the loading of this work). At 10 C, the charge capacity was ~40% of the nominal capacity [29]. For conditions evaluated in this work that achieved >80% capacity retention, the 3.0 V CV for 5 minutes of charge retained ~99% of capacity after 1,000 cycles, while achieving ~70% of the nominal capacity in only 5 minutes. This is for cell loading that achieved initial low rate capacity of 1.46 mAh cm⁻²—where the combination of cycle life and fast charge capacity is among the highest we have found in the literature for loading >1 mAh cm⁻². It is noted here that in this work batteries were only evaluated using 2032-type coin cell form factor, and in future efforts pouch cells would be desirable to further support the fast charge assessment. In a recent report assessing fast charge capabilities of Li-ion cells, pouch format cycle stability and rate capability were found to be much improved relative to identical electrodes and electrolytes assessed in coin cell form factor [30], although it is noted that other factors become more relevant at increasing battery scale such as thermal management or degradation processes such as gassing from electrolyte decomposition [31].

Explicit fast charging criteria are highly targeted to the product or application and can vary greatly. Here we provide some context for broader fast charge targets that are publicly available. These metrics are only noted for fast charge metric context, because as mentioned above this work only assessed coin cell form factors. For practical applications such as electric vehicles, the United States Council for Automotive Research (USCAR) has listed goal metrics for low-cost and fast-charge batteries. These metrics include cycle life of 1,000 cycles and usable energy of 80% within in 15 mins of charging [32]. In addition, the FY25 release 2 of Department of Energy Small Business Innovation Research and Small Business Technology Transfer Research program also listed fast charge targets—from 20% to 80% state of charge within 10 mins charging and cycle life of 1,000 cycles [33]. These targets are intended for larger form factor batteries assembled into packs with many other metrics and tradeoffs to consider, and thus should not be directly compared to the cycling outcomes for the cells in this work; however, the cells herein have shown promise in being able to maintain capacity under aggressive fast charge conditions for 1,000 cycles. In addition to the cycle life and fast charge capability merits, the ester based electrolyte in this work would be expected to have much improved transport properties at lower temperatures compared to the carbonate electrolytes, as the ester solvents have much lower melting points (below −80 °C) [5].

FIG. 4: (a) Areal capacity and (b) capacity retention after 1,000 cycles achieved from fast charge using CV with the charging voltage indicated on the x-axis and the charging times of 1 min (green dots), 2 min (orange dots), 3 min (red dots), and 5 min (purple dots). (c) Consolidation of the same information from (a) and (b) with the y-axis being the same as in (a) and x-axis being the y-axis from (b). Purple, maroon, orange, and green represent the charging time of 5, 3, 2, and 1 min, respectively, and the voltages corresponding to the specific symbols are indicated on the plot. All data from cells with EA electrolyte.

### P2D Simulation Analysis for Gen2 Electrolyte Cells.

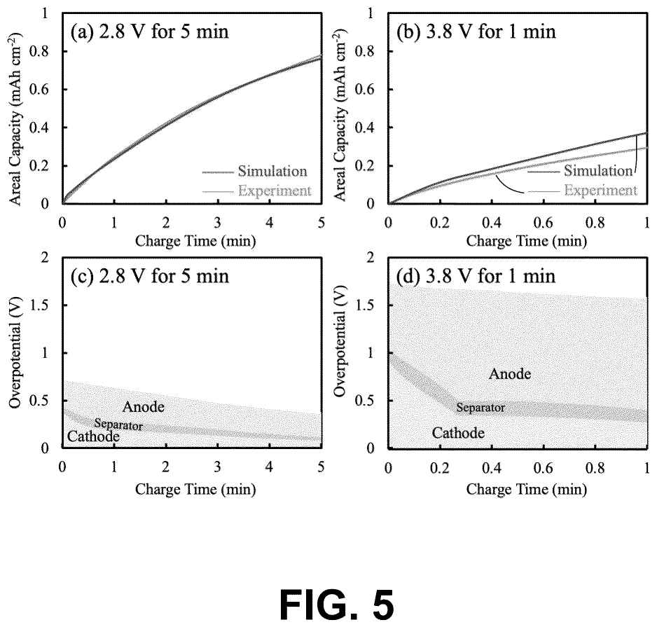

P2D simulations were conducted for 2 extremes of CV conditions evaluated experimentally: the lowest voltage for the longest charge time (2.8 V for 5 min), and highest voltage for the shortest charge time (3.8 V for 1 min). As mentioned earlier, due to availability of detailed transport properties and parameters the P2D simulations were only performed for the Gen2 electrolyte. From the outcomes of these simulations, overpotential distributions were calculated which provide the relative contributions of the different overpotential sources within the cell [23]. FIGS. 5a-b compare the simulation and experimental charge capacity voltage profiles as a function of charge time for the two different CV conditions. The simulation matched the experimental outcome well for the CV condition of 2.8 V for 5 min, while for the CV of 3.8 V for 1 min the simulation had an overestimation of the areal capacity. The target of the simulation was to estimate the relative contributions of different properties and components of the cell in limiting the amount of capacity during the charging process, rather than achieving the best possible match to the experimental data. It is noted that by holding the cell at such a high voltage, the high areal currents achieved of up to 40 mA cm⁻² could cause deviations for assumptions of the P2D model, as 3D heterogeneity within the cell would likely have more significant contributions to electrochemical outcomes.

FIG. 5: Simulated (purple) and experimental (orange) areal charge capacity as a function of charge time for CV charge (a) at 2.8 V for 5 min and (b) at 3.8 V for 1 min. Simulated overpotential contributions at different charge times during CV charge (a) at 2.8 V for 5 min and (b) at 3.8 V for 1 min, where the pale orange, grey, and pale green represent the total overpotential contributions from anode, separator, and cathode, respectively, in the cell.

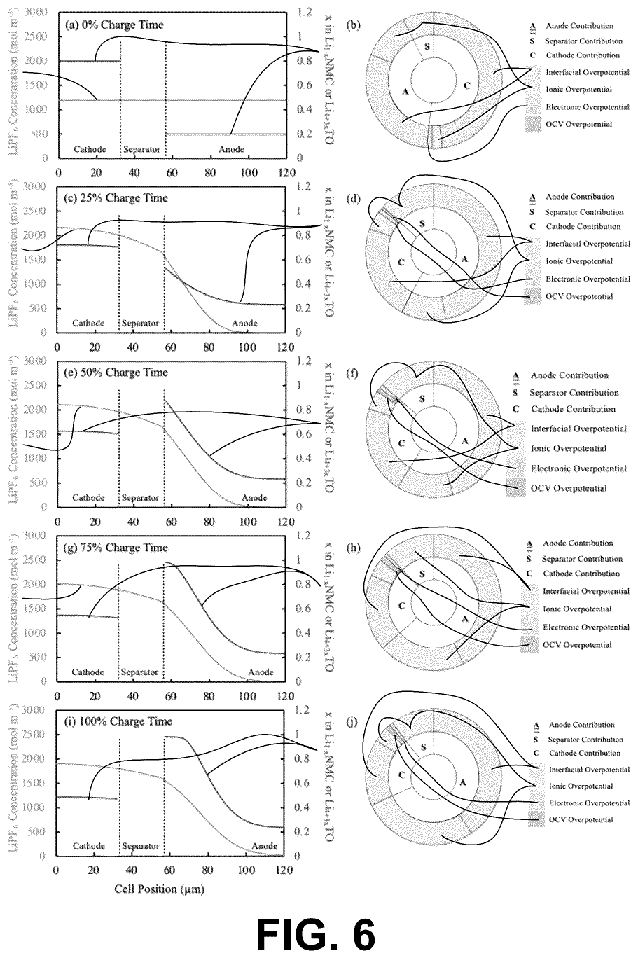

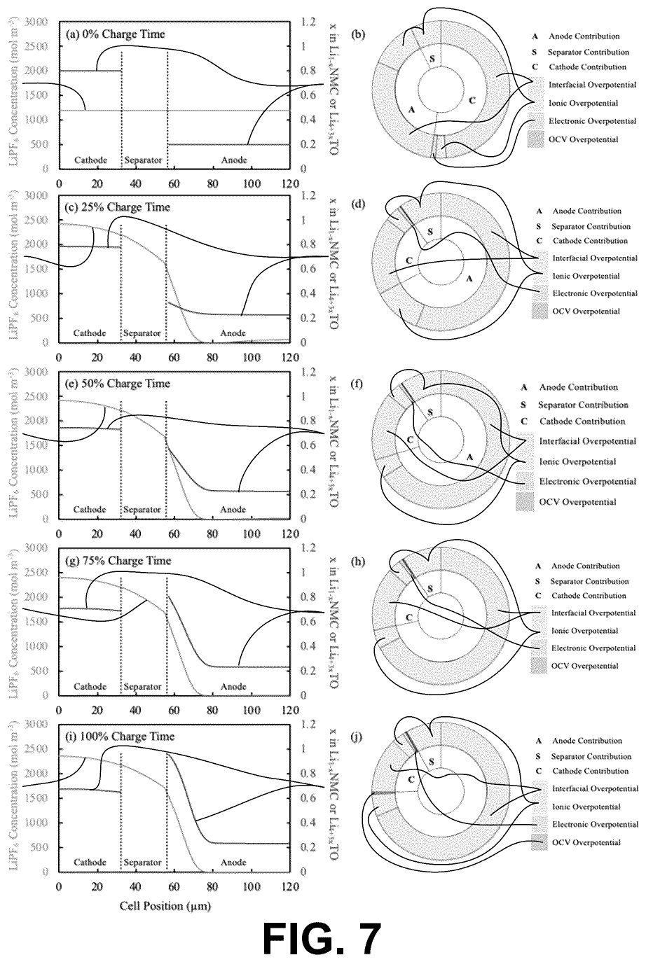

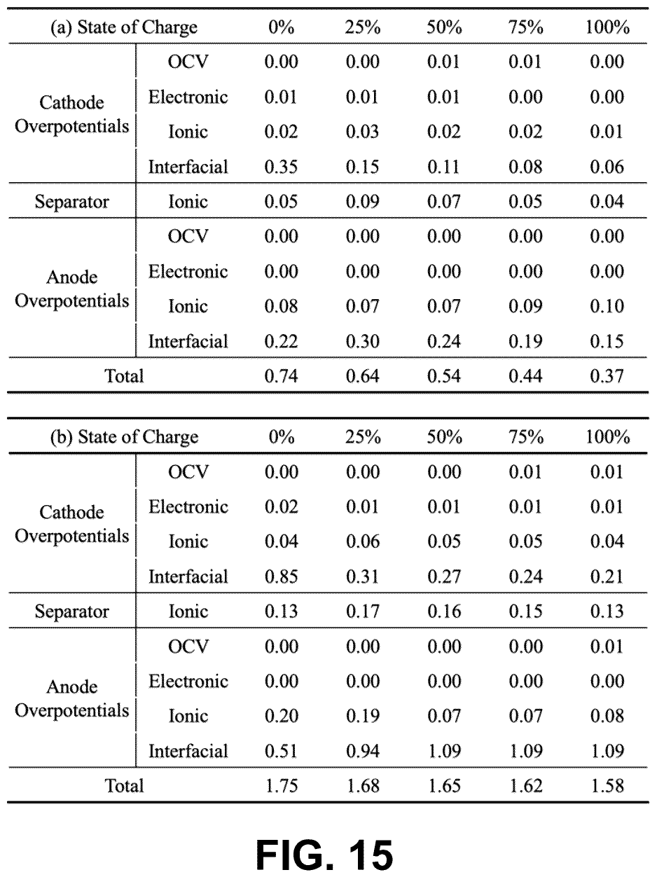

The total overpotential magnitude for the three cell components/regions (anode, separator, and cathode) as a function of charge time are plotted in FIGS. 5c and 5d for CV charge conditions of 2.8 V for 5 min and 3.8 V for 1 min. Some of these calculated values can also be found in tabulated form in Supporting Information, FIG. 15. FIG. 6 and FIG. 7 plot the lithium concentration in the liquid electrolyte and solid electroactive material phases (left column), and more detailed overpotential contributions (right column) at 0%, 25%, 50%, 75%, and 100% of the charge process time. These outcomes are all extracted from the simulations using Gen2 electrolyte parameters and the other relevant cell and material parameters as described earlier.

In reviewing the 2.8 V for 5 min CV results (FIG. 5a, FIG. 5c, and FIG. 6), the total cumulative overpotential gradually decreased as a function of time, which was a consequence of the charging conditions of fixed charge voltage and thus decreasing current density with time. During the earliest portion of the charge, the cathode and anode overpotential contributions were of a similar magnitude (FIG. 5c). As the charge process continued, the cathode relative contribution decreased, where during the last part of the charge process the cathode contributed <20% of the cell overpotential. The ionic overpotential contribution from the separator region remained less than 10% of the total overpotential throughout the charge process. The overall anode overpotential increased slightly until ~20% of the total charge time had elapsed, and then slightly decreased as a function of time until the end of the charge process. At the start of the charge (0% charge time), interfacial overpotential was the greatest source of overpotential both for the anode and cathode, with the cathode providing slightly more total overpotential. At 25% charge time (1.25 min), the Li⁺ concentration in the electrolyte phase was depleted in about half of the anode (FIG. 6c). Relatively more Li⁺ intercalated closer to the separator region in the anode, while the Li⁺ concentration change (and thus electrochemical reaction) was more homogenous for the cathode. This outcome resulted from the different electroactive materials' OCVs as a function of lithiation [23,34]. The NCM811 had a more sloped OCV as a function of lithiation, while LTO had a flat OCV. A sloped OCV will reduce gradients in electrochemical activity within the electrodes, because if a region differentially participates more in the electrochemical reaction (e.g., near the separator region of the electrode), the less reacted material has a more favorable thermodynamic driving force to drive overcoming other overpotentials such as ionic overpotential within the electrode microstructure. A material with a flat OCV, such as LTO, does not have this thermodynamic driving force to mitigate lithiation and electrochemical activity gradients. Thus, the anode reaction became more localized and less uniform in the cell, and the anode overpotential contribution became the main contributor to cell overpotential, including having ionic overpotential fraction increased. As the charging proceeded to the end of the charge process, the Li⁺ concentration gradient and depletion in the electrolyte phase was slightly relieved, which was a consequence of the decreasing charge current with time during the CV charging. The anode still contributed the most overpotential towards the end of charge, but the ionic overpotential fraction had a larger relative contribution and the interfacial overpotential had a relatively lower contribution. Such observation could be attributed to the reaction front in LTO anode, where the LTO in the separator region already achieved nearly full lithiation and could no longer accept more lithium (see ~60 μm region in FIG. 6g and FIG. 6i). In that region, the current must travel in the ionic electrolyte phase, and the intercalation process and electrochemical reaction must occur closer towards the current collector due to lack of remaining capacity near the separator region. In contrast, the cathode overpotential contribution became less, because in the Butler-Volmer equation the interfacial overpotential is negatively related to Li⁺ concentration and the relatively larger number of still available sites/capacity for lithiation in the NCM811 cathode.

For the 3.8 V CV charge for 1 min (FIG. 5b, FIG. 5d, and FIG. 7), the overall trends during the charge process were similar to the 2.8 V for 5 min CV process described above, except for a few minor differences. First, at 25% charge time, the Li⁺ depletion in the electrolyte phase in the anode was more severe for the 3.8 V charge. This was because the initial current was much higher for the higher voltage driving force. Another difference was that until the end of charge process, the interfacial overpotential still dominated. This was because in contrast to the 2.8 V CV the charge time was shorter, thus the lithiation in the LTO in the separator region had not reached full lithiation yet for the higher voltage charging process. Another consequence of the shorter duration was that the Li⁺ concentration in the electrolyte phase remained above zero for only about one fourth of the anode, thus restricting further Li⁺ intercalation into LTO in electrode regions closer to the current collector side of the cell. An additional note here is that the anode interfacial overpotential started as 0.5 V, quickly rose above 0.9 V, and stayed above 1.0 V for the remainder of the charge process. Because the OCV of LTO remained at 1.5 V vs Li/Li⁺, taking into account this interfacial overpotential, the liquid electrolyte could be exposed to voltages as low as 0.5 V vs Li/Li⁺, which would be expected to be in a range that would drive electrolyte reduction and decomposition. The electrolyte decomposition reactions were not part of the electrochemical model, but in practice would be expected to contribute current in the real cells. Although the capacity fade for Gen2 cells was not that dramatic, we speculate that the cause of the greater increase in capacity fade at higher charging voltage for the cells with EA electrolyte may have been this low potential in the anode region that could drive electrolyte decomposition processes. Thus, the limiting factor for cell capacity may have been the anode, where improved electrolyte transport properties or interfacial kinetics may alleviate this limitation.

### Conclusions

In this work, full battery cells with NCM811 cathodes and LTO anodes were evaluated for fast charge, where the fast charge process included constant voltage charge using different charge voltages and durations of the charging timescale. Two electrolytes were investigated experimentally, a more conventional Gen2 electrolyte containing cyclic carbonates, and a higher conductivity electrolyte containing ethyl acetate solvent. To further understand the consequences of the CV charging process, simulations were conducted for two of the extremes of the charging process conditions for the Gen2 electrolyte cells. Simulations suggested the transport properties of electrolyte, and the interfacial kinetics in the anode, were the rate limiting factors for the current density and stability during the charging process. These cells showed promising initial results using CV as a charging protocol for LTO anode cells, where for multiple charging conditions >50% charge capacity was achieved in 3 minutes or less. For many of these fast charge cells, capacity retentions of >80% were achieved after 1,000 aggressive fast charge cycles. While LTO anodes limit overall cell voltage and energy density, the ability to initiate aggressive fast charge conditions may be desirable in some battery applications.

FIG. 6: Information extracted from P2D simulations of the charging process for CV charge at 2.8 V for 5 min. The left column is the lithium concentration in the liquid electrolyte (orange) and solid electrode (purple) phases for (a) 0%, (c) 25%, (e) 50%, (g) 75%, and (i) 100% of the charge process time. Detailed overpotential contributions are shown in right column, corresponding to relative time of the charge process of (b) 0%, (d) 25%, (f) 50%, (h) 75%, and (j) 100%. The letters in the inner rim A, S, and C represent the contributions from anode, separator, and cathode; Pale orange, pale green, pale blue, and grey represent the interfacial, ionic, electronic, and OCV overpotentials for the given regions.

FIG. 7: Information extracted from P2D simulations of the charging process for CV charge at 3.8 V for 1 min. The left column is the lithium concentration in the liquid electrolyte (orange) and solid electrode (purple) phases for (a) 0%, (c) 25%, (e) 50%, (g) 75%, and (i) 100% of the charge process time. Detailed overpotential contributions are shown in right column, corresponding to relative time of the charge process of (b) 0%, (d) 25%, (f) 50%, (h) 75%, and (j) 100%. The letters in the inner rim A, S, and C represent the contributions from anode, separator, and cathode; Pale orange, pale green, pale blue, and grey represent the interfacial, ionic, electronic, and OCV overpotentials for the given regions.

### 2. Example 2

### Supplemental Information.

### Model Description:

The model is 1-D implicit numerical, based on Newman's work [1,2]. The followings are the system of equations, including those partial differential equations, used in this work:

### Electrolyte Concentration:

$$ϵ \frac{\partial c}{\partial t} = \frac{\partial }{\partial x} ( {D}_{eff} ( c ) \frac{\partial c}{\partial x} ) \pm A j ( 1 - {t}_{+}^{0} )$$

### Electrode Solid Potential:

$$\frac{\partial {ϕ}_{1}}{x} = \frac{- {i}_{1}}{σ}$$

### Electrode Liquid Potential:

$$\frac{\partial {ϕ}_{2}}{x} = - \frac{{i}_{2}}{{κ}_{eff} ( c )} + \frac{2 R T}{F} ( 1 + \frac{\partial ln {f}_{A} ( c )}{\partial ln c} ) ( 1 - {t}_{+}^{0} ) \frac{\partial ln c}{\partial x}$$

### Lithium Insertion Kinetics:

$$j = - 2 k {{c}^{0.5} ( {c}_{s}^{surface} )}^{0.5} {( {c}_{s}^{surface} - {c}_{s , max}^{surface} )}^{0.5} Sinh ( \frac{F}{R T} ( {ϕ}_{1} - {ϕ}_{2} - η ) )$$

### Electrode Liquid Current:

$$Aj = - \frac{1}{F} \frac{\partial {i}_{2}}{\partial x}$$

### Volumetric Surface Area:

$$A = \frac{3}{{r}_{0}} ( 1 - ϵ )$$

### Electrode Solid Current:

I=i₁+i₂

### Solid Particle Concentration:

$$\frac{\partial {c}_{s}}{\partial t} = {D}_{s} ( \frac{1}{{r}^{2}} \frac{\partial }{\partial r} ( {r}^{2} \frac{\partial {c}_{s}}{\partial r} ) )$$

### Effective Ionic Conductivity and Diffusivity:

$$\frac{{κ}_{eff} ( c )}{κ ( c )} = \frac{{D}_{eff} ( c )}{D ( c )} = {ϵ}^{α}$$

TABLE S1
Electrode parameters used in simulations.

| Parameters | Cathode value | Anode value |
|---|---|---|
| Thickness (μm) | 32, Manufacturer | 63, Manufacturer |
| Solid State Li⁺ Diffusivity (m² s⁻¹) | 5 × 10⁻¹³ [3] | 6.8 × 10⁻¹⁵ [4] |
| Active Material Radius (m) | 8 × 10⁻⁶ [5] | 2 × 10⁻⁷ [6] |
| Porosity | 0.37, Manufacturer | 0.32, Manufacturer |
| Electroactive Material Vol % | 0.48, Manufacturer | 0.52, Manufacturer |
| Bruggeman Exponent | 2.4 [7] | 2.98 [8] |
| Rate Constant (m^{2.5} mol^{-0.5} s⁻¹) | 3.2 × 10⁻¹¹ [9] | 1 × 10⁻¹² [10] |
| Electronic conductivity (S m⁻¹) | 0.18 [7] | 100 [8] |
| Open Circuit Voltage (V) | −19.873x⁶ + 65.095x⁵ − | 0.21 × Exp(−116.96y) + 0.45 × |
| | 84.587x⁴ + 55.137x³ − | Exp(−5000y) + 0.27706 × |
| | 17.819x² + | Exp(−1010.1y) + 1.56, |
| | 0.867x + 4.65 [11] | 0 ≤ y ≤ 1.0 |
| | | in Li_{4+3y}Ti₅O₁₂ [12] |

TABLE S2
Electrolyte and other parameters used in the simulation.

| Electrolyte and Other Parameters | Value |
|---|---|
| $Transference number , {t}_{+}^{0}$ | 0.415 [13] |
| Initial Concentration (mol m⁻³) | 1200, Experimental |
| $Thermodynamic Factor , ( 1 + \frac{\partial ln {f}_{\pm }}{\partial ln c} ) ( 1 - {t}_{+}^{0} )$ | 0.28687 c² + 0.74678 c + 0.44103 [14] |
| Conductivity (S m⁻¹) | 0.1297c³ + 2.51c^{1.5} + 3.329c [14] |
| Diffusivity (m²s⁻¹) | (−6.9444c² + 7.3611c + 2.65) × 10⁻¹⁰, c < 0.8, |
| | 6.4753 × Exp(−0.573c) × 10⁻¹⁰, c ≥ 0.8 [14] |
| Temperature (K) | 298.15, Room Temperature |
| Gas Constant (J K⁻¹ mol⁻¹) | 8.3145 |
| Faraday Constant (A s mol⁻¹) | 96485 |
| Separator Thickness (μm) | 25, Manufacturer |
| Separator Bruggeman Exponent | 2.2 [15] |

List of Symbols

| | |
|---|---|
| Electronic Conductivity | σ |
| Ionic Conductivity | κ |
| Liquid Li⁺ Concentration | c |
| Solid Li⁺ Concentration | cₛ |
| Solid Potential | φ₁ |
| Liquid Potential | φ₂ |
| Porosity/Electrolyte Volume Fraction | ε |
| Li⁺ Insertion | j |
| Surface Overpotential | η |
| Discharge Current Density | I |
| Solid Phase Current Density | i₁ |
| Liquid Phase Current Density | i₂ |
| Volumetric Solid Particle Surface Area | A |
| Solid Particle Radius | r₀ |
| Electrolyte Diffusivity | D |
| Solid State Diffusivity | Dₛ |
| Bruggeman Exponent | α |
| Transference number | t₊⁰ |
| Faraday Constant | F |
| Temperature | T |
| Gas Constant | R |

FIG. 8: Ionic conductivity as a function of LiPF₆ concentration in solvents of EA (blue) and Gen2 (red) [14,16].

FIG. 9: First cycle charge and discharge voltage profiles for (a) LTO half cell (blue) and NCM half cell (black) at C/20 (0.075 mA cm⁻²) with Gen2 electrolyte, and for (b) full cells with LTO and NCM using EA (blue) and Gen2 (red) electrolyte at C/10 (0.15 mA cm⁻²).

FIG. 10: (a) Rate capability for EA (blue) and Gen2 (red) full cells. Exemplar charge/discharge voltage profiles for (b) Gen2 and (c) EA electrolytes at same charge/discharge rates. The corresponding rates for (b) and (c) were the same for charge and discharge, and corresponded to C/10 (green), 1 C (blue), 5 C (red), and 10 C (purple).

FIG. 11: Nyquist plot from EIS on freshly made LTO/NCM811 cells before cycling with EA (blue) and Gen2 (red) electrolytes.

FIG. 12: Capacity as a function of cycle number for cells with Gen2 electrolyte and CV charging conditions of (a) 2.8 V for 5 min, (b) 3.2 V for 5 min, (c) 3.4 V for 1 min, and (d) 3.8 V for 1 min. Blue and orange dots represent the charge and discharge capacity, respectively. Every 100 cycles included an initial cycle with CC charge and discharge at C/10, followed by 99 cycles where the charge was CV at the voltage indicated on the figure, and the discharge was CV at 1.0 V.

FIG. 13: Capacity as a function of cycle number for cells with EA electrolyte and CV charging conditions of (a) 2.8 V for 5 min, (b) 3.0 V for 5 min, (c) 3.2 V for 5 min, (d) 3.0 V for 3 min, (e) 3.2 V for 3 min, (f) 3.4 V for 3 min, (g) 3.2 V for 2 min, (h) 3.4 V for 2 min, (i) 3.6 V for 2 min, (j) 3.4 V for 1 min, (k) 3.6 V for 1 min, and (l) 3.8 V for 1 min. Every 100 cycles included an initial cycle with CC charge and discharge at C/10, followed by 99 cycles where the charge was CV at the voltage indicated on the figure, and the discharge was CV at 1.0 V.

FIG. 14: Areal capacity achieved using CV fast charge for the different voltage and charging time conditions indicated on the figures. (a, c) Areal current and power and (b, d) areal capacity as a function of charge time. Exemplar profiles were for CV charging conditions of (a, b) 3.2 V for 5 min and (c, d) 3.8 V for 1 min. For all plots in the figure, results for cells with Gen2, Gen2H, EA, EAL electrolyte are represented by red solid, red dash, blue solid, and blue dashed curves, respectively.

FIG. 15: Quantitative value of the voltage associated with each overpotential source extracted from simulations at different state of charges for charging conditions at (a) 2.8 V for 5 min and (b) 3.4 V for 1 min.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

### C. REFERENCES

References are cited herein throughout using the format of reference number(s) enclosed by parentheses corresponding to one or more of the following numbered references. For example, citation of references numbers 1 and 2 immediately herein below would be indicated in the disclosure as (Refs. 1 and 2).

### References for Example 1

Ref 1 J. B. Goodenough, Y. Kim, Challenges for rechargeable Li batteries, Chem. Mater. 22 (2010) 587-603. https://doi.org/10.1021/cm901452z.
Ref 2 C. Cai, H. Dong, G. M. Koenig, Anisotropic particle synthesis and characterization for lithium-ion battery electrode materials via precursor precipitate growth inhibitor, PowderTechnol. 394 (2021) 214-224. https://doi.org/10.1016/j.powtec.2021.08.060.
Ref 3 C. Cai, G. M. Koenig, Investigating Dopants to Improve Sintered LiMn2O4 Spinel Electrode Electrochemical Cycling Limitations, Electrochim. Acta. 401 (2021) 139484. https://doi.org/10.1016/j.electacta.2021.139484.
Ref 4 C. Cai, G. M. Koenig, Electronically conductive metal oxide incorporation in electrode to enable high energy density all active material electrodes, J. Electroanal. Chem. 950 (2023) 117920. https://doi.org/https://doi.org/10.1016/j.jelechem.2023.117920.
Ref 5 C. Cai, B. Min, D. Yost, G. M. J. Koenig, Combining Ester Solvent-Containing Electrolytes with All-Active Material Electrodes for High Current Density Lithium-Ion Batteries, ACS Appl. Energy Mater. 6 (2023) 11226-11233. https://doi.org/10.1021/acsaem.3c02085.
Ref 6 C. Cai, D. Yost, G. M. Koenig, Increased cycling rates for thick all active material electrodes via electrolyte modifications, J. Energy Storage. 64 (2023) 107238. https://doi.org/10.1016/j.est.2023.107238.
Ref 7 M. Ebner, D. W. Chung, R. E. Garcia, V. Wood, Tortuosity anisotropy in lithium-ion battery electrodes, Adv. Energy Mater. 4 (2014) 1-6. https://doi.org/10.1002/aenm.201301278.
Ref 8 L. Hille, H.-C. Toepper, C. Schriever, J. Kriegler, J. Keilhofer, M. P. Noecker, M. F. Zaeh, Influence of Laser Structuring and Calendering of Graphite Anodes on Electrode Properties and Cell Performance, J. Electrochem. Soc. 169 (2022) 60518. https://doi.org/10.1149/1945-7111/ac725c.
Ref 9 Z. Nie, R. Parai, C. Cai, D. Ghosh, G. M. Koenig, Improving high rate cycling limitations of thick sintered battery electrodes by mitigating molecular transport limitations through modifying electrode microstructure and electrolyte conductivity, Mol. Syst. Des. Eng. 6 (2021) 708-712. https://doi.org/10.1039/d1me00082a.
Ref 10C. Cai, G. M. Koenig, Enhancing low electronic conductivity materials in all active material electrodes through multicomponent architecture, Energy Adv. (2023) 308-320. https://doi.org/10.1039/D2YA00269H.
Ref 11C. Cai, L. Gao, T. Sun, G. M. J. Koenig, Stable Multicomponent Multiphase All Active Material Lithium-Ion Battery Anodes, ACS Appl. Mater. Interfaces. 15 (2023) 34662-34674. https://doi.org/10.1021/acsami.3c02896.
Ref 12C. Cai, D. Hensley, G. M. Koenig, High capacity rechargeable coin cells using all active material electrodes and percolated networks of LiCoO2 blended with LiNi0.8Co0.15Al0.05O2, J. Alloys Compd. 968 (2023) 171965. https://doi.org/https://doi.org/10.1016/j.jallcom.2023.171965.
Ref 13C. Cai, Z. Nie, G. M. Koenig, Multicomponent two-layered cathode for thick sintered lithium-ion batteries, Mater. Adv. (2022) 4200-4212. https://doi.org/10.1039/d1maOl074c.
Ref 14C. Cai, G. M. Koenig, Processing Temperature Impact on TiNb2O7 Thick All Active Material Lithium-Ion Battery Electrodes, J. Electrochem. Soc. 170 (2023) 10529. https://doi.org/10.1149/1945-7111/acb403.
Ref 15X.-G. Yang, T. Liu, C.-Y. Wang, Innovative heating of large-size automotive Li-ion cells, J. Power Sources. 342 (2017) 598-604. https://doi.org/https://doi.org/10.1016/j.jpowsour.2016.12.102.
Ref 16Y. Xiong, Y. Liu, L. Chen, S. Zhang, X. Zhu, T. Shen, D. Ren, X. He, J. Qiu, L. Wang, Q. Hu, H. Zhang, New Insight on Graphite Anode Degradation Induced by Li-Plating, ENERGY Environ. Mater. 5 (2022) 872-876. https://doi.org/https://doi.org/10.1002/eem2.12334.
Ref 17H. Zhang, Y. Yang, D. Ren, L. Wang, X. He, Graphite as anode materials: Fundamental mechanism, recent progress and advances, Energy Storage Mater. 36 (2021) 147-170. https://doi.org/https://doi.org/10.1016/j.ensm.2020.12.027.
Ref 18Z. Choi, D. Kramer, R. Mönig, Correlation of stress and structural evolution in Li4Ti5O12-based electrodes for lithium ion batteries, J. Power Sources. 240 (2013) 245-251. https://doi.org/10.1016/j.jpowsour.2013.03.185.
Ref 19G.-J. Chen, W.-H. Chung, Evaluation of Charging Methods for Lithium-Ion Batteries, Electronics. 12 (2023). https://doi.org/10.3390/electronics12194095.
Ref 20A. Nyman, M. Behm, G. Lindbergh, Electrochemical characterisation and modelling of the mass transport phenomena in LiPF6-EC-EMC electrolyte, Electrochim. Acta. 53 (2008) 6356-6365. https://doi.org/10.1016/j.electacta.2008.04.023.
Ref 21T. F. Fuller, Simulation and Optimization of the Dual Lithium Ion Insertion Cell, J. Electrochem. Soc. 141 (1994) 1. https://doi.org/10.1149/1.2054684.
Ref 22E. Martinez-Rosas, R. Vasquez-Medrano, A. Flores-Tlacuahuac, Modeling and simulation of lithium-ion batteries, Comput. Chem. Eng. 35 (2011) 1937-1948. https://doi.org/10.1016/j.compchemeng.2011.05.007.
Ref 23C. Cai, D. Hensley, G. M. K. Jr, Simulated discharge overpotential distributions for sintered electrode batteries in rechargeable coin cell form factors, J. Energy Storage. 54 (2022) 105218. https://doi.org/10.1016/j.est.2022.105218.
Ref 24X.-G. Yang, C.-Y. Wang, Understanding the trilemma of fast charging, energy density and cycle life of lithium-ion batteries, J. Power Sources. 402 (2018) 489-498. https://doi.org/https://doi.org/10.1016/j.jpowsour.2018.09.069.
Ref 25C. Wang, S. Wang, L. Tang, Y.-B. He, L. Gan, J. Li, H. Du, B. Li, Z. Lin, F. Kang, A robust strategy for crafting monodisperse Li4Ti5O12 nanospheres as superior rate anode for lithium ion batteries, Nano Energy. 21 (2016) 133-144. https://doi.org/https://doi.org/10.1016/j.nanoen.2016.01.005.
Ref 26D. Mu, Y. Chen, B. Wu, R. Huang, Y. Jiang, L. Li, F. Wu, Nano-sized Li4Ti5O12/C anode material with ultrafast charge/discharge capability for lithium ion batteries, J. Alloys Compd. 671 (2016) 157-163. https://doi.org/https://doi.org/10.1016/j.jallcom.2016.02.095.
Ref 27B. Zhao, X. Deng, R. Ran, M. Liu, Z. Shao, Facile Synthesis of a 3D Nanoarchitectured Li4Ti5O12 Electrode for Ultrafast Energy Storage, Adv. Energy Mater. 6 (2016) 1500924. https://doi.org/https://doi.org/10.1002/aenm.201500924.
Ref 28C. Liu, F. Xu, Y. Liu, J. Ma, P. Liu, D. Wang, C. Lao, Z. Chen, High mass loading ultrathick porous Li4Ti5O12 electrodes with improved areal capacity fabricated via low temperature direct writing, Electrochim. Acta. 314 (2019) 81-88. https://doi.org/https://doi.org/10.1016/j.electacta.2019.05.082.
Ref 29A. Jaiswal, C. R. Horne, O. Chang, W. Zhang, W. Kong, E. Wang, T. Chern, M. M. Doeff, Nanoscale LiFePO4 and Li4Ti5O12 for High Rate Li-lon Batteries, J. Electrochem. Soc. 156 (2009) A1041. https://doi.org/10.1149/1.3223987.
Ref 30Y. Son, H. Cha, T. Lee, Y. Kim, A. Boies, J. Cho, M. De Volder, Analysis of Differences in Electrochemical Performance Between Coin and Pouch Cells for Lithium-Ion Battery Applications, ENERGY Environ. Mater. 7 (2024) e12615. https://doi.org/https://doi.org/10.1002/eem2.12615.
Ref 311. Belharouak, G. M. Koenig, T. Tan, H. Yumoto, N. Ota, K. Amine, Performance Degradation and Gassing of Li4Ti5O12/LiMn2O, J. Electrochem. Soc. 159 (2012) A1165-A1170. https://doi.org/10.1149/2.013208jes.
Ref 32USABC, (n.d.). https://uscar.org/usabc/.
Ref 33DOE SBIR, (n.d.). https://science.osti.gov/sbir/Funding-Opportunities/FY-2025.
Ref 34C. Cai, Z. Nie, J. P. Robinson, D. S. Hussey, J. M. LaManna, D. L. Jacobson, G. M. Koenig, Thick Sintered Electrode Lithium-Ion Battery Discharge Simulations: Incorporating Lithiation-Dependent Electronic Conductivity and Lithiation Gradient Due to Charge Cycle, J. Electrochem. Soc. 167 (2020) 140542. https://doi.org/10.1149/1945-7111/abc747.

### References for Example 2

Ref 1 M. Doyle, Comparison of Modeling Predictions with Experimental Data from Plastic Lithium Ion Cells, J. Electrochem. Soc. 143 (1996) 1890. https://doi.org/10.1149/1.1836921.
Ref 2 T. F. Fuller, Simulation and Optimization of the Dual Lithium Ion Insertion Cell, J. Electrochem. Soc. 141 (1994) 1. https://doi.org/10.1149/1.2054684.
Ref 3 J. Sturm, A. Rheinfeld, I. Zilberman, F. B. Spingler, S. Kosch, F. Frie, A. Jossen, Modeling and simulation of inhomogeneities in a 18650 nickel-rich, silicon-graphite lithium-ion cell during fast charging, J. Power Sources. 412 (2019) 204-223. https://doi.org/https://doi.org/10.1016/j.jpowsour.2018.11.043.
Ref 4 Y. H. Rho, K. Kanamura, Li⁺ ion diffusion in Li4Ti5O12 thin film electrode prepared by PVP sol-gel method, J. Solid State Chem. 177 (2004) 2094-2100. https://doi.org/https://doi.org/10.1016/j.jssc.2004.02.018.
Ref 5 C. Wang, Y. Jing, D. Zhu, H. L. Xin, Atomic Origin of Chemomechanical Failure of Layered Cathodes in All-Solid-State Batteries, J. Am. Chem. Soc. 146 (2024) 17712-17718. https://doi.org/10.1021/jacs.4c02198.
Ref 6 C. Cai, D. Hensley, G. M. K. Jr, Simulated discharge overpotential distributions for sintered electrode batteries in rechargeable coin cell form factors, J. Energy Storage. 54 (2022) 105218. https://doi.org/10.1016/j.est.2022.105218.
Ref 7 C.-H. Chen, F. Brosa Planella, K. O'Regan, D. Gastol, W. D. Widanage, E. Kendrick, Development of Experimental Techniques for Parameterization of Multi-scale Lithium-ion Battery Models, J. Electrochem. Soc. 167 (2020) 80534. https://doi.org/10.1149/1945-7111/ab9050.
Ref 8 A. Rozenblit, W. R. Torres, A. Y. Tesio, E. J. Calvo, Effect of particle size in Li4Ti5O12 (LTO)-LiMn2O4 (LMO) batteries: a numerical simulation study, J. Solid State Electrochem. 25 (2021) 2395-2408. https://doi.org/10.1007/s10008-021-05020-x.
Ref 9 M. Zhuo, G. Offer, M. Marinescu, Degradation model of high-nickel positive electrodes: Effects of loss of active material and cyclable lithium on capacity fade, J. Power Sources. 556 (2023) 232461. https://doi.org/https://doi.org/10.1016/j.jpowsour.2022.232461.
Ref 10A. G. Kashkooli, G. Lui, S. Farhad, D. U. Lee, K. Feng, A. Yu, Z. Chen, Nano-particle size effect on the performance of Li4Ti5O12 spinel, Electrochim. Acta. 196 (2016) 33-40. https://doi.org/https://doi.org/10.1016/j.electacta.2016.02.153.
Ref 11J. Liu, S. Chavan, S.-C. Kim, Investigation of the Electrochemical and Thermal Characteristics of NCM811-21700 Cylindrical Lithium-Ion Battery: A Numerical Study and Model Validation, Energies. 16 (2023). https://doi.org/10.3390/en16176407.
Ref 12C. Cai, Z. Nie, J. P. Robinson, D. S. Hussey, J. M. LaManna, D. L. Jacobson, G. M. Koenig, Thick Sintered Electrode Lithium-Ion Battery Discharge Simulations: Incorporating Lithiation-Dependent Electronic Conductivity and Lithiation Gradient Due to Charge Cycle, J. Electrochem. Soc. 167 (2020) 140542. https://doi.org/10.1149/1945-7111/abc747.
Ref 13C. Capiglia, Y. Saito, H. Kageyama, P. Mustarelli, T. Iwamoto, T. Tabuchi, H. Tukamoto, 7Li and19F diffusion coefficients and thermal properties of non-aqueous electrolyte solutions for rechargeable lithium batteries, J. Power Sources. 81-82 (1999) 859-862. https://doi.org/10.1016/S0378-7753(98)00237-7.
Ref 14A. Nyman, M. Behm, G. Lindbergh, Electrochemical characterisation and modelling of the mass transport phenomena in LiPF6-EC-EMC electrolyte, Electrochim. Acta. 53 (2008) 6356-6365. https://doi.org/10.1016/j.electacta.2008.04.023.
Ref 15D. P. Finegan, S. J. Cooper, B. Tjaden, O. O. Taiwo, J. Gelb, G. Hinds, D. J. L. Brett, P. R. Shearing, Characterising the structural properties of polymer separators for lithium-ion batteries in 3D using phase contrast X-ray microscopy, J. Power Sources. 333 (2016) 184-192. https://doi.org/10.1016/j.jpowsour.2016.09.132.
Ref 16C. Cai, B. Min, D. Yost, G. M. J. Koenig, Combining Ester Solvent-Containing Electrolytes with All-Active Material Electrodes for High Current Density Lithium-Ion Batteries, ACS Appl. Energy Mater. 6 (2023) 11226-11233. https://doi.org/10.1021/acsaem.3c02085.

What is claimed is:

1. A battery, comprising:
an anode comprising a lithium-silicon compound, lithium-tin alloys, or lithium titanate (Li₄₊ₓTi₅O₁₂, where 0≤x≤3);
a cathode comprising a lithium transition metal oxide or lithium transition metal phosphate; and
an electrolyte;
wherein the battery has the characteristic to be charged via a constant voltage only charging protocol, wherein the battery has the characteristic of being able to be charged to about 50% capacity in about 2-10 minutes.

2. The battery of claim 1, wherein the anode comprises one or more materials selected from niobium oxide, titanium oxide, and molybdenum oxide.

3. The battery of claim 1, wherein the lithium transition metal phosphate within the cathode comprises one or more materials selected from LiFePO₄, LiMnPO₄, LiNiPO₄, LiCoPO₄, LiFeₓMn₍₁₋ₓ₎PO₄ (0<X<1), and LiNiₓCo₍₁₋ₓ₎PO₄ (0<X<1).

4. The battery of claim 1, wherein the lithium transition metal oxide within the cathode comprises one or more materials selected from LiNi_{0.8}Co_{0.1}Mn_{0.1}O₂, LiCoO₂, LiMn₂O₄, LiNi_{0.5}Mn_{1.5}O₄, and LiNi_{0.8}Co_{0.15}Al_{0.05}O₂.

5. The battery of claim 1, wherein the battery has the characteristic of being able to be charged to about 50% capacity in about 2-4 minutes.

6. The battery of claim 1, wherein the anode is free of graphite.

7. The battery of claim 1, wherein the anode has a thickness of about 5 μm to about 200 μm, wherein the cathode has a thickness of about 5 μm to about 100 μm.

8. The battery of claim 1, wherein the anode has a porosity of about 20 vol % to about 50 vol %, wherein the cathode has a porosity of about 20 vol % to about 50 vol %.

9. The battery of claim 1, wherein the battery has the characteristic of being able to be charged to about 70% capacity in about 4-6 minutes.

10. The battery of claim 1, wherein the cathode further comprises about 1 wt % to about 10 wt % conductive carbon, wherein the anode further comprises about 1 wt % to about 10 wt % conductive carbon, or both.

11. The battery of claim 1, wherein the electrolyte comprises a lithium salt and an organic solvent.

12. The battery of claim 11, wherein the organic solvent is selected from the group consisting of: ethyl acetate, methyl acetate, propyl acetate, ethyl formate, ethyl methyl carbonate, ethylene carbonate, 1,2-dimethoxyethane, and a mixture thereof.

13. The battery of claim 1, wherein the battery has an areal capacity of about 1 mAh cm⁻² to about 2.5 mAh cm⁻².

14. A method of charging a battery, comprising:
charging a lithium ion battery using only constant voltage charging;
wherein the lithium ion battery comprises an anode, a cathode, and an electrolyte; and
wherein the anode comprises Li₄Ti₅O₁₂, wherein the lithium ion battery retains at least about 80% of battery capacity after 1000 charging cycles, wherein about 50% or more of charging capacity is achieved in about 2 to 10 minutes.

15. The method of claim 14, wherein during the method, Li plating does not occur, wherein the anode comprises Li₄Ti₅O₁₂, wherein the anode is free of graphite, or both.

16. The method of claim 14, wherein about 50% or more of charging capacity is achieved in about 2 to 4 minutes.

17. The method of claim 14, wherein about 70% of charging capacity is achieved about 4-6 minutes.

18. A charging system, comprising:
the battery of claim 1; and
a charger;
wherein the charger is configured to charge the battery using a constant voltage charging protocol; and

19. The charging system of claim 18, wherein the charger is configured to charge the battery to about 70% capacity in about 4 to 10 minutes.

20. The charging system of claim 18, wherein the charger is configured to not use a constant current protocol during charging.
